(19) United States
(12) Patent Application Publication
(10) Pub. No.: US 2005/0187866 A1
(43) Pub. Date: Aug. 25, 2005

(54) Method and system for executing financial transactions via a communication medium

(76) Inventor: Andre S. Lee, Seoul (KR)

Correspondence Address: WHITE & CASE LLP;PATENT DEPARTMENT, 1155 AVENUE OF THE AMERICAS, NEW YORK, NY, 10036, US

(21) Appl. No.: 11/005,846

(22) Filed: Dec. 6, 2004

Related U.S. Application Data
(63) Continuation of application No. 09/712,059, filed on Nov. 14, 2000, now abandoned.
(60) Provisional application No. 60/166,112, filed on Nov. 16, 1999.
(60) Provisional application No. 60/176,410, filed on Jan. 13, 2000.
(60) Provisional application No. 60/182,998, filed on Feb. 16, 2000.

(51) Int. Cl. G06F 17/60

(52) U.S. Cl. 705/39; 705/35

(57) ABSTRACT

A web-based method and system that facilitates business transactions, including the raising of capital in global financial markets via the Internet is described. Users of the system design, structure, analyze and execute business transactions over the Internet. Users of the system described include issuers, financial institutions, intermediaries, other professional advisors (law firms, accounting firms, translation agencies, etc.) and end investors. A security means controls access to the system and restricts access to the system to only qualified users. Users of the system design and diagram a transaction structure, assign corresponding attributes to the structure design. The structure design and corresponding attributes are stored in a database. The transaction is posted as a notice or interest onto the system, wherein a user maintains the posting. A database of user and transaction information is compiled and maintained. The user profile is compared with the posted transactions to identify transactions of interest to a user. The transaction information is communicated to the user. The transaction is executed, including issuing new securities or buying or selling previously issued securities through an auction or trade process. The system provides users direct access to its community, which includes, but is not limited to, issuers, investors, intermediaries, and advisors such as law firms, consultancy firms, accounting firms, and translation agents.

This application claims the benefit of U.S. Provisional Application No. 60/166,112, filed Nov. 16, 1999; U.S. Provisional Application No. 60/176,410, filed Jan. 13, 2000; and U.S. Provisional Application No. 60/182,998, filed Feb. 16, 2000.

### FIELD OF THE INVENTION

The invention relates to a method and system for executing business transactions including financial transactions such as issuing new securities and buying, selling and trading previously issued securities by means of a communication medium. Specifically, the invention relates to a method and system for executing financial transactions via the Internet.

### BACKGROUND OF THE INVENTION

In current and traditional marketplaces all over the world, companies raise capital through the issuance of securities in a financial transaction or deal. This market is commonly referred to as the “primary market” as distinguished from the “secondary market” in which previously issued securities are bought and sold. Securities may come in many forms, including debt and equity securities as well as non-standard instruments such as structured notes.

Generally, there are four types of participants involved in a capital raising process through the issuance of securities: (1) issuers; (2) financial intermediaries; (3) end investors; and (4) other intermediaries. Issuers include corporations, municipalities, foreign and domestic governments and their agencies and investment trusts. Financial intermediaries typically include banks, savings and loan institutions, insurance companies and brokerage firms. End investors are the eventual holders of the securities being issued. Other intermediaries include lawyers, accountants, auditors, paying agents, fiscal agents, trustees, and other entities or professionals that provide a service to the issuers or intermediaries.

Issuers may be of different sizes. Small to medium-sized issuers generally are corporate or financial institutions that are typically less well known and require relatively small tranches to be raised. Often the costs for raising smaller amounts of capital do not justify a capital market transaction. These small to medium-sized issuers are thus normally restricted to local commercial banks, which sometimes results in transactions involving unfavorable terms, including fees and commissions. Small or medium-size boutique financial institutions may have the human resources and expertise but lack the well established tools, processes, and marketing network that an institutional intermediary or investor has, to carry out efficient execution and distribution of new issues. Traditionally, due to limited physical presence and resources in local markets, these institutions have limited ability to service a wide variety of issuers and limited distribution capabilities. There are now an increasing number of such institutions. On the other hand, medium to large-sized issuers typically have a better brand presence, are better capitalized, and are more well known, at least within a regional investment community, and are familiar with the capital raising process. Such issuers typically can easily access the international capital markets.

The process of raising capital by issuing securities is similar in markets all over the world and across various instruments. For example, the process of raising capital by issuing bonds, a type of debt security, is representative of most instruments and involves several steps. Generally, an issuer mandates and appoints a manager, also known as lead manager or arranger, which is usually a financial intermediary. The arranger manages the issuance process on behalf of the issuer. The issuer and the financial intermediary together determine the type of securities to issue. The financial intermediary conducts due diligence research on the issuer's viability and ability to meet financial obligations. Once the mandate is sent, the arranger assembles participants to carry out the deal, which includes for example, members of a syndicate (co-lead managers, co-arrangers), lawyers, accountants, fiscal/trustee agents and paying agents. The syndicate, also known as the underwriting group or the purchase group, is usually a group of investment bankers operating under an agreement to purchase a new issue of securities from an issuer for resale to the investment public. The arranger conducts due diligence on the issuer and prepares an offering memorandum or prospectus that describes the company, its operating environment, the transaction, potential risks to investors etc. Lawyers for the various participants prepare the documents necessary to execute the transaction. Members of the syndicate invite end investors to subscribe to the deal and purchase the newly issued securities. Changes to the draft documents are negotiated among the participants. Once all the necessary documents and offering memorandum have been drafted, negotiated and finalized by all the participants, the “signing” takes place. Terms of the instrument are finalized and all the documents are signed. At what is typically called a “closing,” listing requirements of the security are confirmed and any supporting documents such as legal opinions, auditors' opinions etc., are exchanged. The instrument then comes into effect.

This typical securities issuance process requires the various participants and their representatives to coordinate their schedules to be available for and participate in numerous telephone conferences or face-to-face drafting sessions. This process is complicated further when the participants are physically located in different countries, continents, and/or time zones. Usually, one participant prepares an initial draft document, receives comments from the other participants, incorporates the comments, revises the documents and redistributes the documents to all the participants, for review and additional comments. This traditional procedure requires much wasted paper due to photocopying of the documents, as well as time and cost of distribution either by facsimile and/or courier services. The advent of the electronic mail system reduced distribution costs and time. However, drafting, revising and finalizing documents sent as email attachments raises issues concerning different versions created by different entities, incompatibility of word processing software as well as security of email communication.

### SUMMARY OF THE INVENTION

The present invention is a web-based application that facilitates business transactions, including the raising of capital in global financial markets via the Internet. The invention offers the ability to design, structure, analyze and execute transactions over the Internet. The invention also offers its users direct access to its community, which includes, but is not limited to, issuers, investors, intermediaries, and advisors such as law firms, consultanting firms, accounting firms, and translation agents.

The invention provides a method for executing financial transactions, by designing and diagramming a structure for a transaction, assigning corresponding attributes to the structure design, creating and posting the transaction, wherein a user maintains the posting, identifying a transaction of interest to a user, and executing the transaction, including issuing new securities or buying or selling previously issued securities through an auction or trade process. New securities may also be issued through an on-line syndication.

The invention is a method for executing transactions on a network of computer-based systems, including an Internet-based system by: providing a secure means including restricting and controlling access to the system to only qualified users; designing and diagramming a transaction structure; assigning corresponding attributes to the structure design; storing the structure design and corresponding attributes in a database; posting the transaction as a notice or interest onto the system, wherein the posting is maintained by a user; compiling and maintaining a database of user and transaction information; identifying transactions of interest to a user by comparing the user profile information with the posted transaction information; communicating the transaction information; and executing the transaction, including issuing new securities (e.g., through an on-line syndication) or buying or selling previously issued securities through an auction or trade process.

The invention provides a network of computer-based systems, including an Internet-based system for executing financial transactions that includes: (i) workstations for receiving and displaying transaction information; (ii) an operative database component of user and transaction information; (iii) a storage device; (iv) a processor programmed to maintain the database of user and transaction information, to compare the database of user profile information with respect to posted transactions and match the user's investment profile, and to communicate the transaction information to the user interested in the posted transaction; (v) a load-balancing mechanism to distribute load across the system; (iv) a system, web or application server; (v) a system security means that controls and restricts access to the system to only qualified users of the system; and (iv) a communication means (e.g., the Internet) that transmits communications between the users of the system and the system server, including transaction information to the user interested in the transaction.

The invention also provides a computer readable medium having computer executable instructions for performing a method that includes designing a structure for a transaction diagrammatically, assigning corresponding attributes to the structure design, creating and posting the transaction, the posting maintained by a user, identifying transactions of interest to a user and executing the transaction, including issuing new securities (e.g., through an on-line syndication) or buying or selling previously issued securities through an auction or trade process.

The invention further provides a user with tools and functions to facilitate and carryout the financial transaction in a secure environment. The invention provides a user access to an online global community of other users that include issuers, intermediaries and end investors, irrespective of the user's size, location, and capability to execute a transaction or distribute securities. All users accessing the system of the invention, work on a common platform using standardized deal structuring tools and functions. The system also provides a secure environment for professional advisors such as law firms and accounting firms to receive mandates online from issuers, intermediaries and investors and to upload documentation, review and work with other participants to revise such documentation.

The invention provides a new and efficient way for all the conventional participants in a financial transaction to perform their roles over the Internet. Users of the invention include: issuers of securities; financial institutions and intermediaries; end investors; and other professionals that play a role in a financial transaction, such as law firms, accounting firms, valuation firms, translation agents etc. One embodiment of the invention limits users in the United States to those who meet certain legal qualifications; specifically, users who are investors may access the system if they are Qualified Institutional Buyers (“QIBs”) as defined by Rule 144A of the Securities Act of 1933 or non-U.S. persons permitted to buy securities in Regulation S transactions.

The invention provides benefits to various parties of a financial transaction. The invention provides up-to-date information indiscriminately to all users irrespective of size and whether known or unknown. By amassing deal information in an accessible online format from markets all over the world and for various products, users are provided accurate and timely market news about various issuers in order to assist the user to make an informed decision. In this way, issuers may understand and closely follow new issue trends in the financial markets and thereby time and structure new issues to obtain favorable pricing terms.

Access to a large number and variety of issuers with different risk profiles from different regions diversifies an investor's risk substantially. The present invention allows a user to gain access to the issuing needs of a wide base of issuers from various regions and to interact with them online to discuss their needs for capital, irrespective of physical location. The invention also assists issuers to design and analyze a financial transaction, create initial draft documents and assess market appetite for their security on an anonymous basis. The invention allows issuers to raise smaller amounts of capital, which may better suit their cash flow needs at lower transaction costs with faster and more efficient execution. The invention also allows financial institutions to better and more efficiently advise their subscribers on structuring deals.

Likewise, the present invention allows small to medium sized issuers to access globally a wider base of financial intermediaries and end investors, that they would not otherwise be able to access. Having an increased choice of investors and the ability to target a specific type of investor, issuers are in a better position to negotiate more favorable covenants on their issuance.

Use of the invention allows a user to realize a significant reduction in costs in the initial targeting of issuers as initial analyses of markets, credit and due diligence can be done economically and efficiently through an on-line platform. Additionally, some financial institutions service a specialized class of investors with specialized buying patterns. The invention's system enables such institutions to target specific issuer communities efficiently. The system's global community presents increased opportunities for investing in specific types of risk profiles.

Providing alternative methods of trading, from simply trading one instrument through a live bid-offer system to more complex mechanics involved in bidding and offering portfolios of instruments, allows investors alternatives to increase liquidity and keep track of trading conditions.

Issuers have the option to control and execute their own deal or to select a financial intermediary to take on that responsibility. The invention gives an issuer the option to execute (i.e., issue, buy or sell) their own deal, reducing significant transaction costs and to give issuers direct contact with investors, streamlining communication to be able to understand an investor's concerns so as to create an optimum deal structure. This process allows for faster execution times for new issues with substantial savings for repetitive and frequent issues.

One of embodiment of the invention involves over-the-counter markets for debt products, derivatives, swaps, and private equity. Sample debt products may include bonds, convertible bonds, loans, and money markets products. Another embodiment of the invention provides product support for interest rate and currency options, interest rate and currency swaps and foreign exchange transactions.

### BRIEF DESCRIPTION OF THE DRAWINGS

FIG. 1 is a legend for the symbols in the flow charts of FIG. 2 through FIG. 13.

FIG. 2A is a flow chart showing the primary issuance process as captured as functions within the invention's system according to an embodiment of the invention.

FIG. 2B is a general diagram showing an overview of the functions that support the present invention.

FIG. 2C is a diagram showing the Maintenance function of the present invention.

FIG. 3 is a flow chart showing the sequence of operations of the Design function of the present invention.

FIG. 4 is a flow chart showing the sequence of operations of the Analysis function of the present invention.

FIG. 5 is a flow chart showing the sequence of operations of the Interest function of the present invention.

FIG. 6 is a flow chart showing the sequence of operations of the Document function of the present invention.

FIG. 7 is a flow chart showing the sequence of operations of the Due Diligence function of the present invention.

FIG. 8 is a flow chart showing the sequence of operations of the Primary Trade function of the present invention.

FIG. 9 is a flow chart showing the sequence of operations of the Secondary Trade function of the present invention.

FIG. 10 is a flow chart showing the sequence of operations of the My Account function of the present invention.

FIG. 11 is a flow chart showing the sequence of operations of the Partners function of the present invention.

FIG. 12 is a flow chart showing the sequence of operations of the Communicate function of the present invention.

FIG. 13 is a flow chart showing the sequence of operations of the Control function of the present invention.

FIG. 14 is a network diagram of the elements of the system of the invention.

FIG. 15 is a graphic illustration of the N Tiers approach of the system of the invention.

FIG. 16 is a graphic illustration of the application logic of the system of the invention.

FIG. 17 is a diagram that shows the hierarchy of layers in Unified Modeling Language (“UML”)

FIG. 18 is a diagram of packages and their corresponding Workflow layer in UML.

FIG. 19 is a diagram of packages of the billing system function in UML.

FIG. 20 is a flow chart showing the sequence of operations for the Rule Engines package of the invention.

FIG. 21 is a table showing details of available functions.

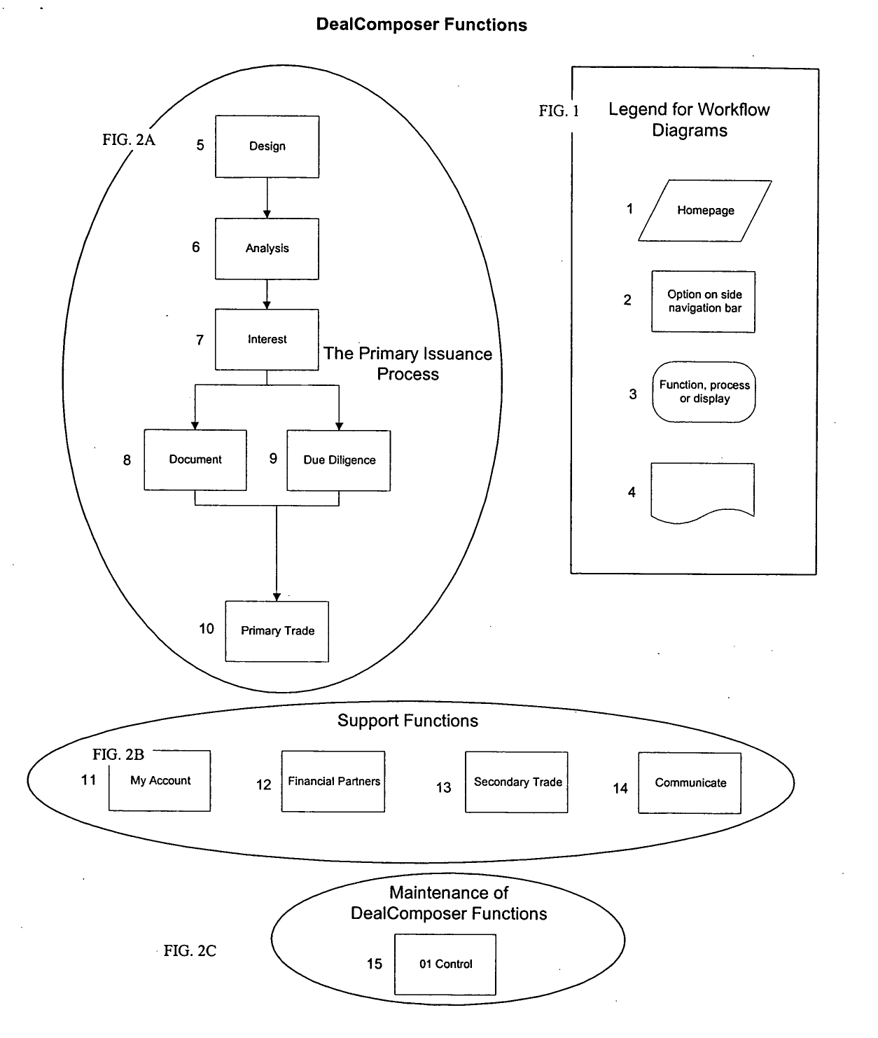

### DETAILED DESCRIPTION OF THE INVENTION

A user may access the invention through a website homepage on the Internet. The URL for the DealComposer website is: http://www.DealComposer.com.

Referring now to the drawings, wherein like reference numerals designate identical or corresponding parts throughout the several views. FIG. 2A is a flow chart showing an overview of the deal process involving new issues of securities. Briefly, a user may design a financial transaction by creating a diagram of the structure of the transaction 5 or select a deal structure from the invention's Deal Library 26. The issuer's credit risk is analyzed 6 by reviewing and testing the issuer's ability to meet its financial obligations under the transaction. In order to identify other users or participants interested in the transaction, the user (“Poster”) creates and posts a notice of the transaction 7. The documents necessary to execute the transaction are created, revised and finalized 8. Due diligence research on the transaction is conducted 9. The transaction is executed and the new securities are distributed 10.

FIG. 2B identifies the Support functions that support the deal process and FIG. 2C shows the Maintenance function of the invention. These functions are described in detail below.

Design Function

The starting point for any financial transaction is to determine which entities will be involved and what instruments the entities will transact or trade. Simple transactions may involve just two entities and an exchange of for example, a bond for cash. A structured transaction however, will often involve three or more entities and several related transactions. The operation and flow of complex structured transactions may be explained to the entities involved through structure diagrams.

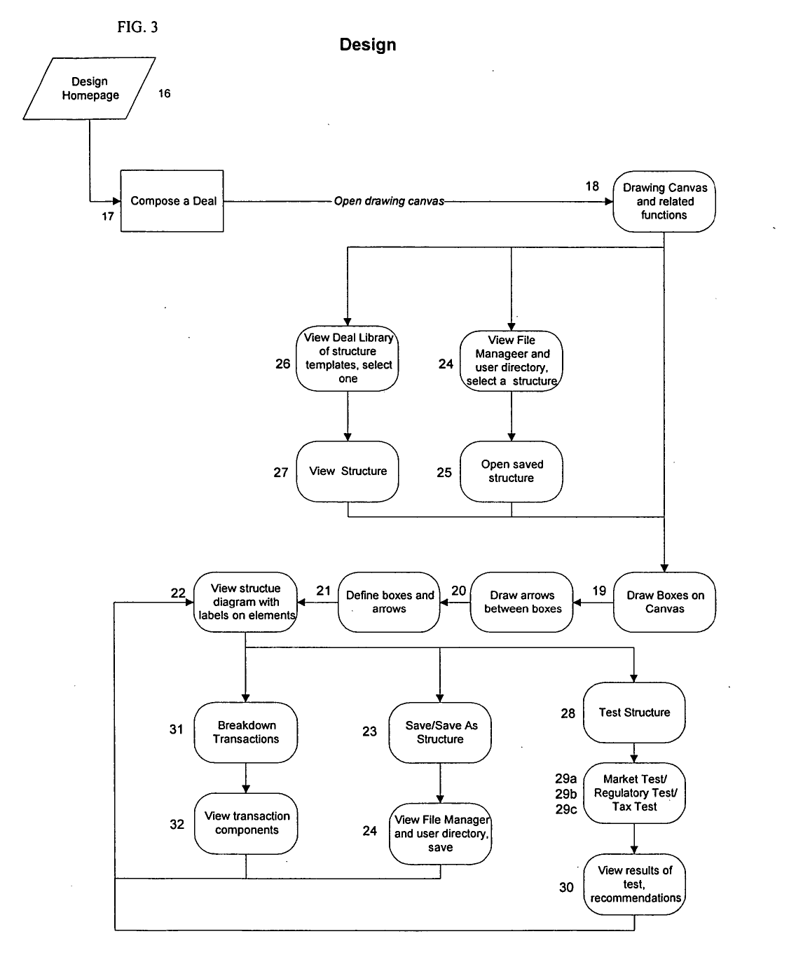

In this regard, the “Design” function of the invention assists a user in designing a financial transaction by providing the user with tools to create a structure diagram for the transaction. Referring to FIG. 3, a user accesses the Design function of the invention's system through a website homepage 16. A user may gain access to the Design function by going to the URL for the DealComposer website, www.DealComposer.com, and entering the Design Homepage 16 and going to the “Compose a Deal” link 17.

A blank drawing canvas 18 is displayed on the computer monitor upon which a user draws boxes and arrows. Boxes are drawn 19 to represent a company or an entity and arrows are drawn 20 to represent a financial instrument (“Event”). The boxes and arrows together represent a financial transaction, which may involve any number of entities and Events. The boxes and arrows may be moved, deleted and re-sized. The user defines attributes of each diagram element (box and arrow) 21 of the structure diagram. For convenience, a blank attribute list for an entity (or a box) is provided to the user. This list of attributes includes e.g., name, address, country or state of incorporation, industry type, rating and basic financial information. Alternatively, the user may work on a blank Event (or arrow) attribute list to fill in specific instrument type, details of issuance, coupon, redemption, security, associated guarantees, options etc. Once the boxes and arrows of the structure diagram are defined, the structure diagram may be viewed 22 and saved 23 to a file in a directory 24 or stored and saved to a database, which may be accessed 24 and opened 25 at a later date. A template for a structure diagram may also be viewed 27 by accessing a database or “Deal Library” 26, which includes a database of structure templates (e.g., straight bonds, bonds with call and put options, bonds with guarantees, money market instruments like commercial paper and bills of exchange). A user has the option to customize a selected template for a particular transaction.

Structure diagrams may be shared with users of the system for collaborative design purposes. For example, a structure diagram may be accessed by more than one user to facilitate collaboration and designing of the transaction.

Another feature of the Design function is the Test Structure feature 28. After creating a structure diagram, any of several tests 29 may be applied to evaluate the viability of the structure and identify potential problems at the design stage itself One test is the Market Test 29a, which compares the defined attributes of the events or arrows against common market practices and prevalent conditions and returns a result or recommendation of suitable changes to the structure 30. These attributes may include issue sizes, coupon spreads and maturities of the instruments. For example, if a Korean Entity was to design a debt instrument for 100 years with a coupon of Libor+10 basis points. Application of the Market Test 29a for example, may recommend that market conditions support a maturity of 5 to 10 years and a coupon spread of say 150 to 200 basis points. The Market Test 29a uses pricing models and data feeds from external sources for data such as foreign exchange rates, interest rates, prices of securities etc.

Another Test Structure feature is the Regulatory Test 29b, which may be applied to test a structure. The Regulatory Test 29b analyzes the instrument types in the structure, the issuing/investing entities and compares them against relevant securities and foreign exchange regulations in the jurisdictions involved. The Regulatory Test 29b identifies potential problems with the structure and recommends suitable solutions in its operation 30. The Regulatory Test 29b uses a database containing regulations from various jurisdictions.

The application of the Tax Test feature 29c on a transaction structure reviews the applicable tax laws that are maintained on a database and generates a response containing a result, recommendation, or consequence of the tax laws 30. For example, applying the Tax Test 29c may invoke a response identifying the withholding tax implications of a given structure. Depending on the instrument type and the countries of the entities or users involved in the transaction, the Tax Test 29c generates a response 30 informing a user of the applicable taxes. A user can then modify the structure to minimize tax liability in accordance with the recommendation or result.

Another feature of the Design function breaks down a complex structured transaction diagram 31 to its individual transaction components 32.

Credit Analysis Function

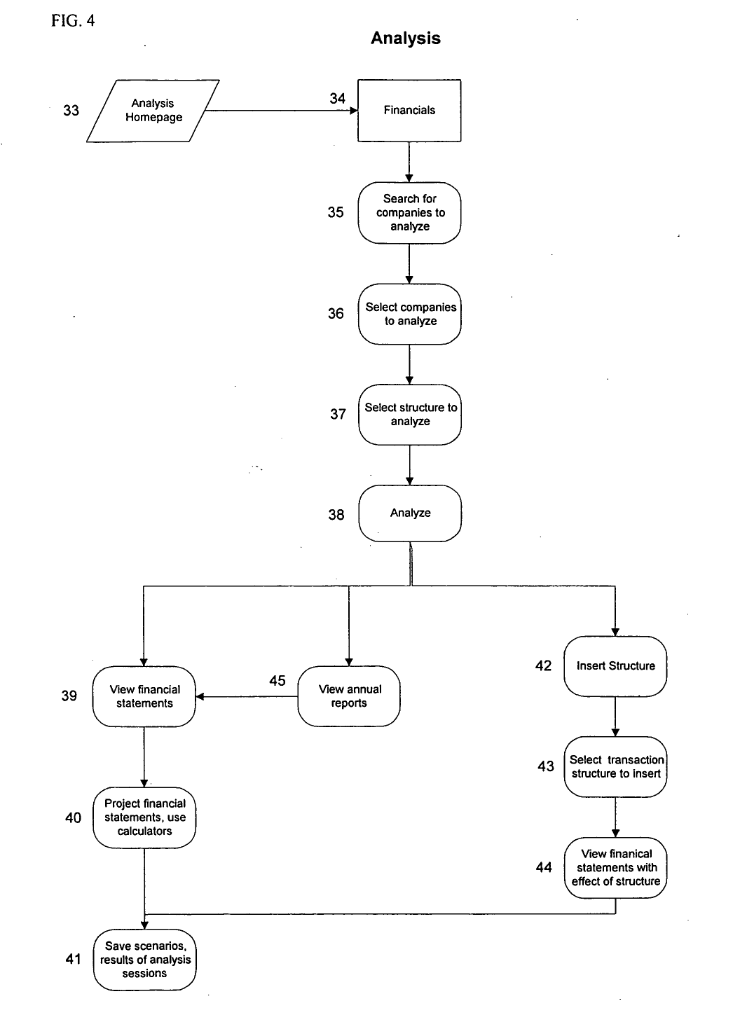

Referring now to FIG. 4. Credit analysis is an important part of any financial transaction especially in the capital raising process. For example, before subscribing to an issue, a prospective investor assesses the credit risk of an issuer, i.e., the capacity of the issuer to honor all financial obligations associated with the transaction. Analysis of the credit risk of a user usually involves testing the ability of a company to meet its payments by projecting its financial statements into the future. Financial statements include for example, a company or issuer's balance sheets, income statements and cash flow statements. Expected future cash flows generated by the company are then compared with the payments to be made as a result of the transaction or issuance. The basic parameters that affect cash flow (revenues, costs, borrowings etc.) are varied to assess the sensitivity of the future cash flows to adverse changes in business conditions.

The Analysis function of the invention assists a user in analyzing the financial statements of a company or issuer. A user may access the Analysis function of the system by going to the Analysis Homepage 33 through www.DealComposer.com and going to the Financials link 34. Financial statements such as balance sheets, income statements and cash flow statements, for various companies in various countries are maintained in a database. A user selects criteria for a company or companies to search 35. From the search results, a user then selects a company or companies 36 and/or a structure or structures 37 to analyze. The selected companies and structures are then analyzed 38 by viewing past financial data 39 (e.g., balance sheet, income statements, cash flow). Financial data may for example be presented in two formats across all countries, one each for manufacturing and financial companies.

Projections of future financial statements are generated by projecting past financial data into the future 40 for a particular company 40. Projections are generated based on a set of assumptions or “scenarios” that can be modified and saved 41 to a file and retrieved from a user's file directory at a later time. Various calculators are provided—for revenues, costs, leverage, profitability etc. These calculators take user inputs in the form of future assumptions of a financial parameter (e.g., growth rate, cost, return, etc.) and generate specific numbers from the data contained in the financial statements. For example, a user can analyze future profitability using a Calculator by adjusting income and cost growth rates for five years into the future and generate expected return on equity figures for the next five years.

Another feature of the Analysis function, called Insert Structure 42, simulates the effect of a transaction on the financial statements of the issuer. A user selects a transaction structure to insert 43 e.g., from a particular deal or a previously saved transaction structure. Cash flows from a transaction structure are overlaid or superimposed onto the financial statements of the company being analyzed to generate simulated financial statements as a result of the transaction. A user can then view 44 and analyze the effect of the transaction on various parameters including profitability, leverage and cash flows of the company. For example, to simulate the effect of a bond issuance on a company's financial data, Insert Structure would operate such that debt would be increased by the amount of the issuance, annual interest payments would be increased by the amount of coupon and principal redemption would decrease the cash balance on maturity. Similarly, the effect of all debt instruments including convertibles, equity instruments and options may also be simulated.

Annual reports of companies are also provided 45 for download usually in PDF files, and may be viewed using software such as Adobe's Acrobat Reader. These annual reports contain auditors' comments and notes to account to give users a better picture of the financial state of the company.

Interest Function

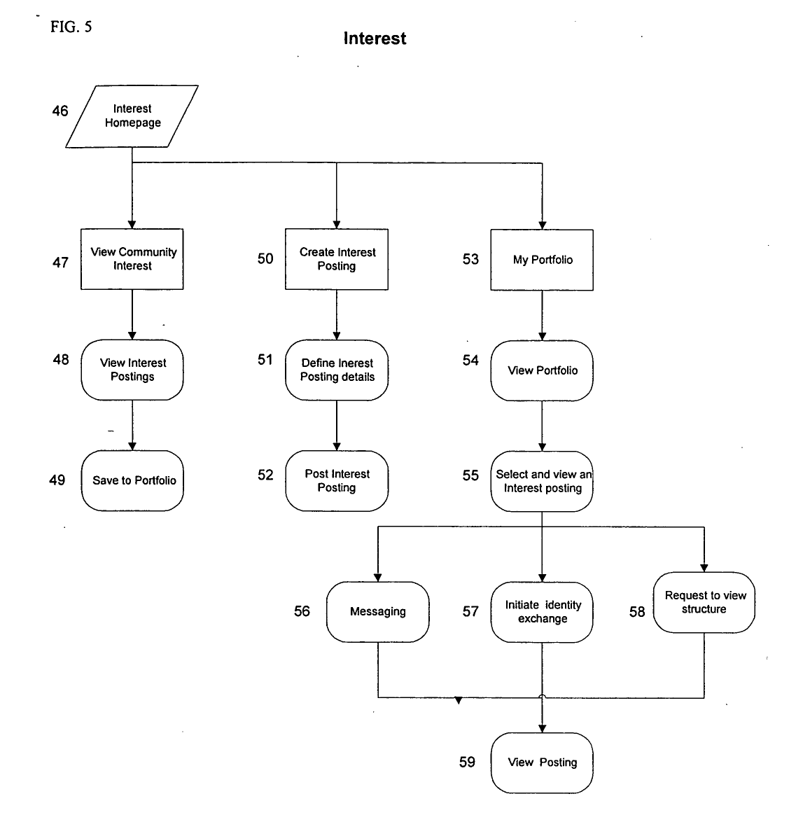

Now referring to FIG. 5. Generally, the Interest function of the present invention serves to bring together participants for a transaction and allows a user to conduct preliminary discussions with potential counter-parties on an anonymous basis until they are ready for further negotiations.

A user accesses the invention's Interest function via a website such as by going to the Interest Homepage 46 found at www.DealComposer.com and going to the Interest Exchange link. A user may browse through a database of proposed primary issuance transactions that have been posted (“Interest Posting”) by other users of the system or “Community” 47. The Interest function provides a snap shot view or window into the primary markets so that a user may see what instruments and structures are being proposed by other users, what deals are in progress and which deals to participate in. A user may select and view an Interest Posting 48 and then save any Interest Postings to a file 49.

A user creates a notice of a proposed transaction or an Interest Posting as an initial step towards executing a transaction. One purpose of the Interest Posting is to solicit responses from suitable and interested counter-parties and participants. In order to create an Interest Posting 50, a user specifies details in the Interest Posting concerning the proposed transaction 51 (e.g., whether the Posting is to buy or sell, the country, industry, instrument, amount, currency, maturity and target audience or the type of user that the Posting is intended to address). Once the details of the Posting are specified, the Interest Posting may be posted and/or saved in the user's My Portfolio 53, which may be accessed at any time. The Interest Posting 52 is done anonymously and may include a proposed structure diagram. The Interest Posting reveals only the country and industry group or type of user submitting the Interest Posting 52. Interest Postings 52 may also be targeted towards particular types of entities. When creating a new Interest Posting 50, a target audience is specified 51 based on criteria such as country or industry group or type. Only users who match this target profile will be tested for a profile fit and be allowed to access the Interest Posting 52. Interest Postings 48 through the Interest Exchange 47 function are open to all users. A user who receives an Interest Posting may follow-up at a later date by saving 49 it to a file in My Portfolio 53. Once the file is created, any subsequent access to the Interest Posting is through the My Portfolio feature 53.

As explained further below, a user defines its user profile in the My Account function by specifying the user's preference for an instrument(s), currency(s), maturity amount(s), etc. for investment and issuance. By specifying the parameters, a user whose profile matches the specification on a given Interest Posting receives a system alert to access the Interest Posting. If interested, a user can contact the user who submitted the Interest Posting for further negotiation. In this way, a user saves the time and effort of scanning and reviewing all the Interest Postings.

The My Portfolio function 53 helps a user to manage the information related to each transaction. A user may view or browse through a listing of the Interest Postings 54 posted by other users of the system and save it to the user's My Portfolio 53, as well as view Interest Postings created by the user itself A user may then select and view 55 a particular Interest Posting for further details. In this way, potential participants for a transaction may be gathered. A user may respond to an Interest Posting by sending a message 56 anonymously to the user who posted the Interest Posting (“Poster”) and request additional information about the transaction. Either user, whether the Poster or recipient, may initiate a mutual exchange of identities 57. If a structure diagram has been attached to the Interest Posting, an interested counter-party may request permission to view the structure 58. In either case, the Poster may choose to accept or reject the request. If the request is accepted, the structure diagram may be viewed 59.

Once an Interest Posting successfully gathers the participants of a transaction, the Poster may transfer the details of the Interest Posting as a Posting for the Primary Trade function as discussed more fully below. All information concerning each of the participants and the structure is copied on to a New Issue Posting.

Document Function

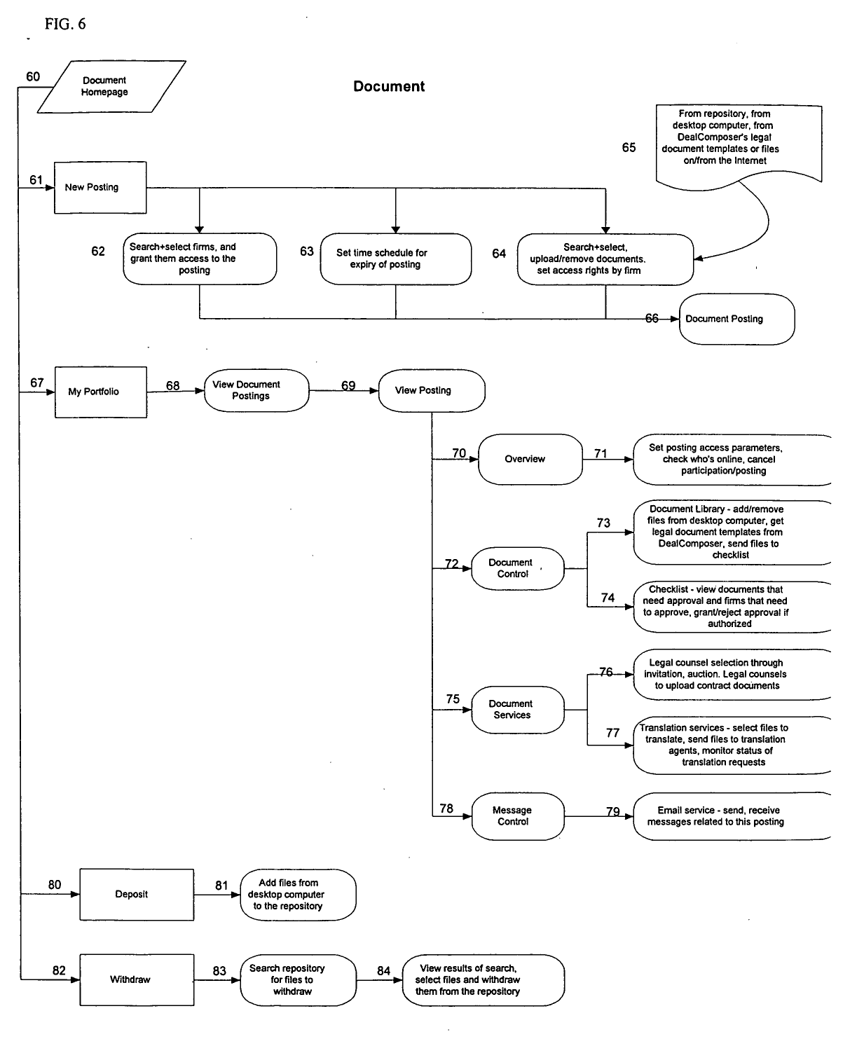

Now turning to FIG. 6. The Document function allows users in a given transaction (e.g., issuers and investors) to work together to prepare transaction documents. Users or participants in a transaction may collaborate on-line to draft and negotiate documents in a transaction. One feature of the Document function allows a user to select a law firm or other professional services (e.g., financial intermediaries, law firms, translation agents and/or accounting firms) to assist or participate in the transaction.

A user may access this function via a website such as the Document Homepage 60 at www.DealComposer.com. A Document Posting is created by a user to post in the New Posting feature 61. The user may designate and control which users have access to the Document Posting 62. A time limit may also be set for the validity of the New Document Posting 63. Documents and reference material required to execute a deal may be gathered by selecting and uploading documents 64 from various pathways including a user's desktop computer or from a repository or a storage area for documents 65. In this way, the user has the ability to post documents in Document Posting 66.

The My Documents Portfolio 67 allows a user in a transaction to manage the documentation process of a transaction. A user may browse through a listing of the Document Postings 68 and select a particular Document Posting to view 69 the documents necessary for the particular transaction.

The Overview feature 70 provides a listing of the postings the user may access. A user who posts the initial document maintains control over the documents. The user who posts the document controls access over the document. A user may reset the posting access parameters, change the time limit 71, cancel a posting or monitor the permitted users' access to a posting at any given time 71. Document Postings may be accessed by any number of authorized users at any time. Individual documents in a posting, however, may only be “checked out” for editing purposes one user at a time. The Document Control feature 72 allows the user to control who has access to the Document Posting. A user also has the option to deposit documents in the Document Library 73. The documents placed in the Document Library may include draft documents that the participants in the transaction are negotiating. Files may only be checked-out or checked-in one at a time from the Document Library 73, and the most recent version is available for review. Although more than one version of a document may exist, each version is available for review by all users; and Document Control 72 informs those users which version is the most recent one. All users with authorized access are apprised of each document's history (i.e., when it was edited, by whom and the current status). Once a document is finalized, it is sent to the system's Checklist feature 74, which is a list of pre-requisites for a significant action. For example, the Checklist feature 74 may list the documents that need to be drafted before an offering memorandum is completed or a list of participants that need to confirm a set of documents before they are deemed final. In the case of a document Checklist, the Checklist feature 74 prompts a user to confirm approval of the document's final status. Once each participant and the respective legal counsel have confirmed its approval, the document is treated as final and no further changes are allowed by the system.

The Document Services feature 75 offers a user the ability to seek and engage the external professional services (e.g., legal counsel and/or a translation service agency) necessary to properly execute a transaction. For example, a financial transaction typically requires external legal counsel to prepare the documentation and/or to provide legal expertise in structuring the transaction. Document Services 75 offers a user the ability to select legal counsel or other external professionals who have partnered onto the invention's system through two methods. A user in need of legal counsel, for example, may send an invitation to various attorneys 76 or a group of law firms describing the kind of legal work required and requesting an estimate of the legal fees. The user can then negotiate a fee with the law firms and select one or more firms to provide legal counsel. Alternatively, a user may hold a separate auction 76 on the system, through which legal counsel or a law firm(s) may bid for the work. Once the user and the selected legal counsel enter into an agreement, the law firm may upload template documents onto the invention's system and assist the user or participants to access and/or draft the appropriate documentation.

As cross-border deals invariably involve different documents and participants from various countries, it may be necessary to translate documentation from one language into another. The present invention also provides users with the ability to engage the services of a translation agency 77 to translate documents as necessary. The Translation feature 77, provides a user with the tools to select a file from the Document Posting 66 and submit a request directly to a translation agent. A translator can send the translated file electronically and also generate an invoice for the requester.

The Message Control feature 78 provides a user with a means for sending and receiving messages from other authorized users who have access to a posting 79.

Using the Deposit feature 80, a user may upload documents 81 from an existing file from, for example, the user's desktop computer. Also, the Withdraw feature 82 within the Documentation Function allows a user to conduct searches for files by inputting criteria for files to search 83 and view. After the Withdraw feature completes the search, the user may select files 84 to withdraw from the results of the search.

Due Diligence Function

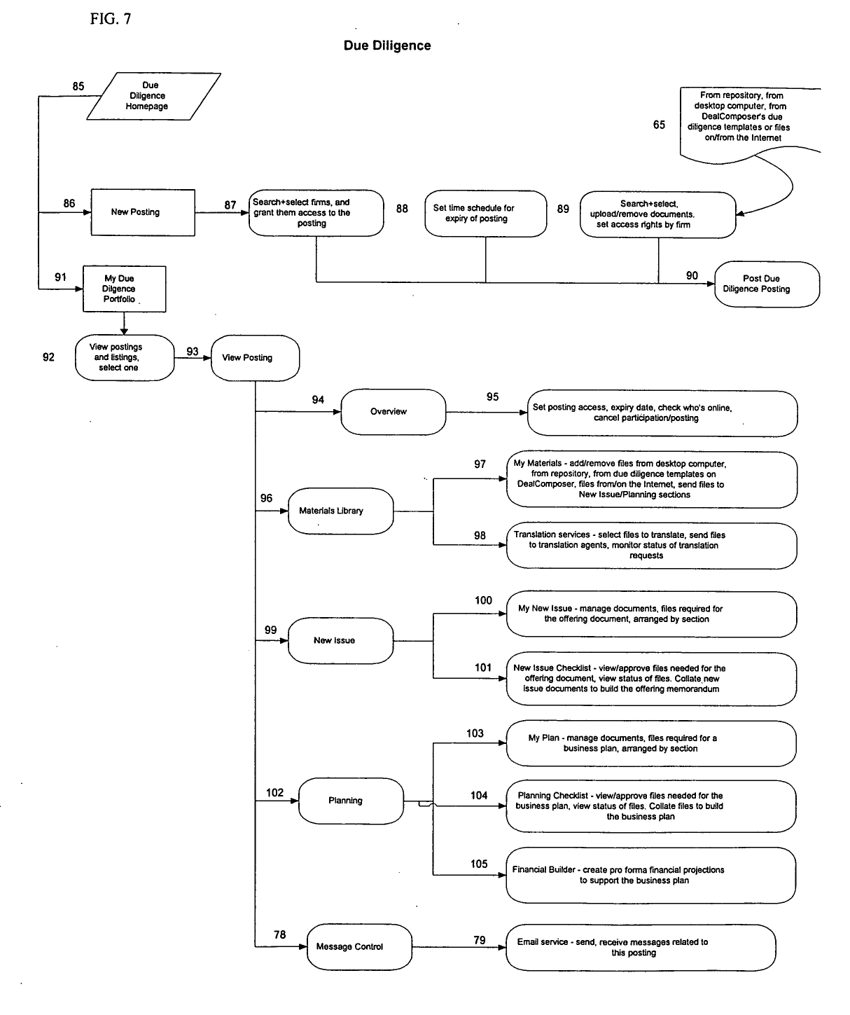

Turning to FIG. 7, the Due Diligence function is similar to the Document Function in that it brings the participants and the supporting materials required to execute a transaction together. These materials may include, for example, due diligence information such as research reports, offering memoranda or business plans for venture capital funding.

A user accesses the Due Diligence function through a website such as the Due Diligence Homepage 85 found at www.DealComposer.com. A user creates a Due Diligence Posting through the New Posting feature 86. The user grants access to other user-participants 87, who are then sent a message or a system alert and asked to participate in the Due Diligence Posting. The user may also set a time limit 88 to keep the posting active or to complete the due diligence work. Documents and other material may be gathered by identifying and uploading documents 89 from various pathways including a user's desktop computer or from a repository 65 that stores all the files uploaded for a particular transaction. This repository 65 is the same repository 65 as used in the Document function. Files can be added to the repository by various pathways including: a user's desktop computer; the repository that stores all previously uploaded documents from the Document function; through a search engine that is available for the user to find relevant documents on the Internet; and from Due Diligence templates, which may be customized for the particular transaction.

Due Diligence templates, for example, may be a set of Microsoft Excel files containing fields for data that a company would typically provide during the course of conventional due diligence. This data includes a breakdown of account headings in the balance sheets, income statements and cash flow statements of companies. A user may download a template, enter the required information and store the completed template in its repository. Templates cover both manufacturing and financial companies and are “linked,” such that once a set of related templates is downloaded, input in one template updates the information in the other templates. For example, changes to a template with a detailed breakdown of product sales would update the income statement template. Time is saved, duplicate entry of data is avoided and due diligence data may be re-used over several transactions.

The user in Add New Due Diligence Posting 90 posts a Due Diligence Posting.

My Due Diligence Portfolio 91 offers the user the ability to manage its participation in a posting. A user that has been granted access to the posting may view or browse through the Due Diligence Posting 92 to select and view 93 the information concerning a particular posting.

The Overview 94 feature provides the authorized user with a listing of the posting. The user may reset the posting access parameters, change the time limit 95, cancel a posting or monitor what postings may be accessed at any given time 95. The Materials Library feature 96 allows a user to deposit or withdraw files 97 with other users that have access to the posting. These files may be deposited into the Materials Library by various pathways including, a user's desktop computer or from the repository 65.

Like the Document function, the Due Diligence function also provides translation services 98. A user may engage the services of and send a file to a translation agent and request translation of a document.

The New Issue 99 feature allows the user to manage and categorize files into the sections 100 that may subsequently form the parts of a standard offering memorandum; that is, the issuer summary, company research, industry analysis etc. A user may upload files through any of the above-mentioned pathways to the relevant section of the New Issue feature. Once all the files have been finalized and agreed upon, the user may “build” the offering memorandum by collating the files 101. The New Issue Checklist 101, like the Document Checklist 74, manages and tracks confirmations from each participant and participating legal counsel. This draft offering memorandum shows a “Red Herring” status until approved by the authorized participants and legal counsel after which the status changes to “Final Circular.”

The Planning feature 102, like the New Issue feature 99, provides the user with the tools to facilitate the drafting of a business plan. My Plan 103 provides the user the means for managing the documents and files concerning a business plan arranged by sections. Once all the files have been gathered, the user may build the business plan. The Planning Checklist 104 manages and tracks the confirmation status of the files.

A Financial Builder feature 105 of the present invention assists a user in preparing draft financial projections or business plans and was designed for start-up companies (e.g., technology and manufacturing companies) or users who may lack the expertise required to draft financial projections or business plans. In order to create a business plan, a user is guided by prompts asking questions on the various aspects of their business (e.g., type of company, expected revenue, expected costs in terms of salaries and office expenses, expenses for manufacture or software development etc.). Once the user provides the necessary information, this feature calculates the expected cash balances at the end of the first five years to indicate the approximate capital or funding requirement. A user can then decide on the amount and timing of the funding—either as equity capital or as debt. Based on these inputs, this feature creates simple financial projections for the first five years of operation, in the form of an income statement, a balance sheet and a cash flow statement. This feature also displays basic financial ratios that a venture capital provider may use to assess the risks and performance of the company.

From this stage, a user can refine its assumptions and fine-tune its plan to a level of detail that a prospective investor would require. This financial information can then be appended to the business plan document drafted in the New Issue 98 feature and sent to possible capital providers.

Primary Trade Function

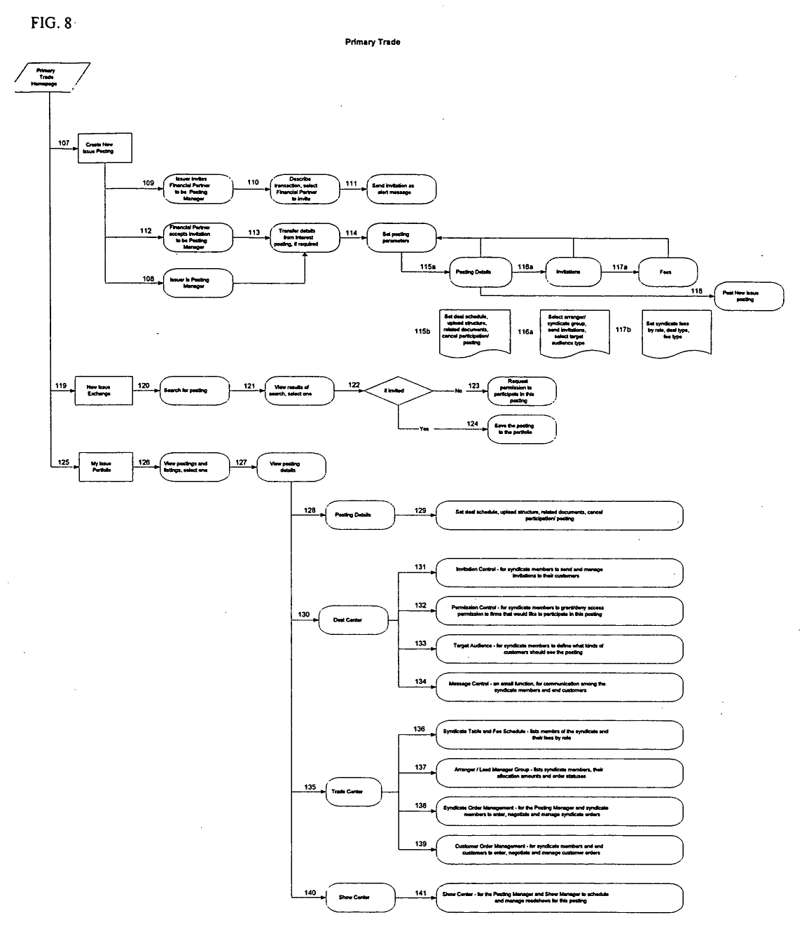

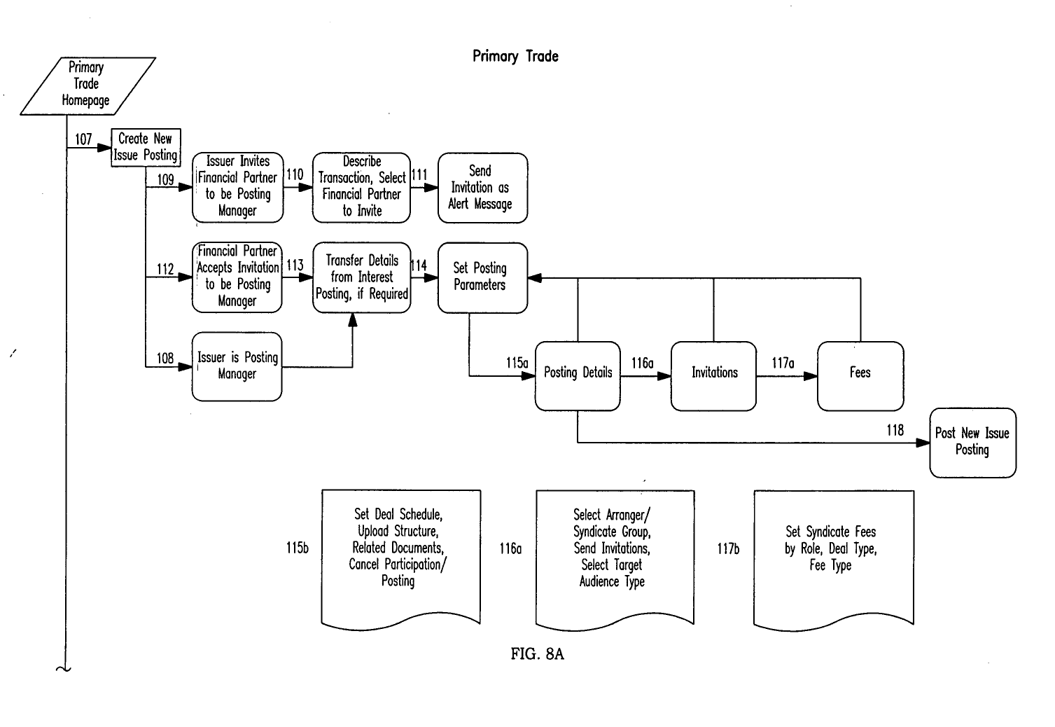

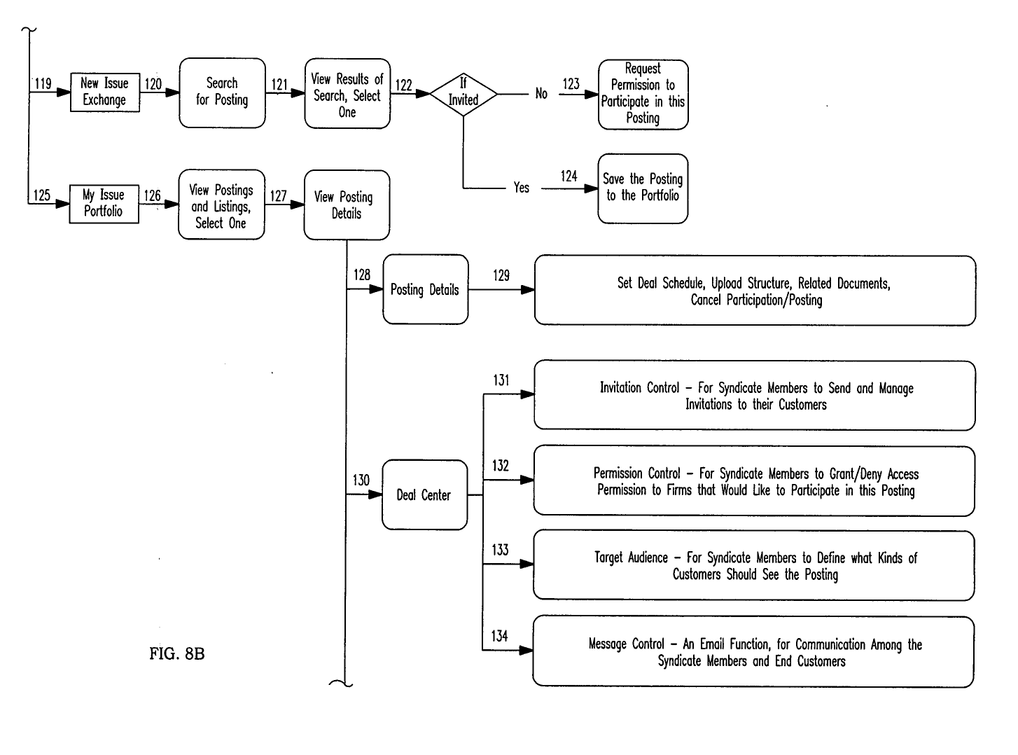

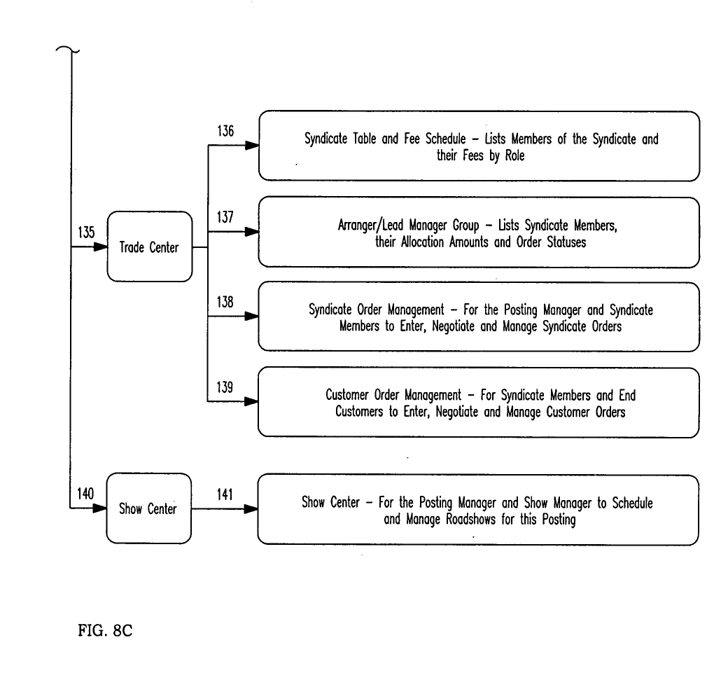

The flowchart of FIG. 8 shows how a primary trade involving the issuance of a new security is executed in the system of the present invention. Accessed through a website 106, a user creates a New Issue Posting 107 as an initial step in executing a transaction or issuing a new security. The “Posting Manger” manages the execution process of the transaction. An issuer of an instrument may designate itself to be the Posting Manager 108 or invite another user or a financial partner to manage the transaction on its behalf 109. A user may invite another user to be the Posting Manager for the transaction by specifying information concerning the transaction 110. The system provides the user a list of possible Posting Managers based upon the information submitted. The user then selects from the listing of potential Financial Partners or may specify another Financial Partner and sends an invitation 111 to the selected user to be the Posting Manager for the transaction. It is the Posting Manager, whether the issuer itself or a Financial Partner who accepts 112 an invitation, who creates a New Issue Posting and controls the transaction execution process.

Access to various functions and/or features of the invention that may be available to each user in this function varies according to the role of the user in the transaction. For example, only a Posting Manager may change the specifications of a transaction or a deal schedule, invite syndicate members and allocate issue amounts to them. Only syndicate members may invite end investors and manage their orders, customers may deal with their respective syndicate members to place their orders.

If an Interest Posting was previously created or used in the Interest function, the information contained in such posting may be transferred 113 to the New Issue Posting. Otherwise, the parameters of the New Issue Posting are selected and defined 114 by the user or Posting Manager.

The user specifies and edits the New Issue Posting Details 115a, which contains information regarding the transaction, the financial instrument, the deal schedule for pre-syndication, the syndication periods, and provides links to the offering memorandum and supporting attachments such as presentations, legal documents and research 115b.

The syndication process is carried out in three stages: pre-syndication; syndication; and post-syndication. The pre-syndication stage primarily involves the syndicate members and the Posting Manager. The Posting Manager, whether the issuer or a Financial Partner has the ability to select and invite the participants to the transaction 116a. These participants include members of the syndicate or end investors 116b.

The Primary Trade Function also has Syndicate Fee Table 117a that displays fees to be paid to each member of the syndicate group. The Table also outlines information on the role of the syndicate member, fee type and other information relating to the deal 117b. Once all the pertinent information is submitted, the New Issue Posting is posted 118 or added to the community posting board, as well as to the My Issue Portfolio of each user involved in the transaction. The Posting Manager must gather the various members of the syndicate by the end of the pre-syndication stage and finalize the amounts to be allocated to each of them. Simultaneously, syndicate members invite their customers and begin negotiating their orders with them. Once the pre-syndication stage is complete and all syndicate members have accepted their allocated amounts, the Posting Manager may “Break the Syndicate.” After the syndicate has been broken, the syndicate orders cannot be changed. Syndicate members then have until the end of the post-syndication stage to finalize their customers' orders. Meanwhile, legal counsel for the issuer, the Posting Manager and each syndicate member finalize the deal documentation by the end of the post-syndication stage. The final draft of the offering memorandum is attached to the Issue Posting prior to the end of the post-syndication period.

During the post-syndication stage, syndicate members finalize their customer orders. At the end of the post-syndication period, all syndicate members and customer orders are confirmed by means such as Allocation Tickets, and the status of the Posting changes to “Closed.”

At any stage, any participant has the ability to withdraw from the transaction and cancel all orders. If the Posting Manager or issuer cancels participation, the entire transaction is terminated. If a syndicate member withdraws from the syndicate, this member's customers have the option to place their orders with another member of the syndicate. Apart from the Posting Manager, syndicate member and end investor, a primary trade may also involve a Show Manager who is responsible for scheduling and executing any road shows associated with the issuance.

Users invited to participate in a transaction may access the New Issue Posting by accessing the New Issue Exchange feature 119. The user may search 120 the system's bulletin board for a posting by specifying the search criteria. From the search results, the user may select to view a New Issue Posting 121. If the user was not invited to participate in or is not authorized to have access to the selected New Issue Posting, then the user must first seek the permission 123 of the Posting Manager in order to participate in the transaction. If the user has access to the New Issue Posting or is a permitted user, then the user may save the New Issue Posting to its My Issue Portfolio 124.

The Issue Portfolio feature 125 assists the user in managing its transactions by allowing a user to browse 126 through a listing of the New Issue Posting created by other users as well as the New Issue Postings created by the user. The user can select and view 127 a particular New Issue Posting entry for further details. In the Posting Details 128, the user may specify 129 information associated with the transaction such as edit the deal schedule, upload structure diagram and cancel access.

The Deal Center 130 is a tool that permits the Posting Manager, the syndicate members and the end investors of the syndicate members to communicate with each other throughout the deal process. The Deal Center 130 includes a function to invite end investors and syndicate members 131, to grant permission to users 132 who express an interest in participating in the transaction, and a function to target certain types of end investors 133. The Data Center also features an electronic messaging function 134.

The purpose of the Trade Center 135 is to send, receive and manage orders, while monitoring the status of each order and the status of the syndicate. The system provides a Syndicate Table and a Fee Schedule 136 that lists the members of the syndicate and the information relating to the fees paid to each member of the syndicate group, including the role of each syndicate member and fee type. If the user is the Posting Manager or “arranger,” then additional information 137 will be displayed including amounts allocated to each syndicate member and the status of any orders. Syndicate members place orders with the Posting Manager 138 and end investors place orders with their respective syndicate members 139. Also available is a messaging function across syndicate and customer groups and a section displaying the members of the syndicate, their roles, their fees and the status of each of their participation in the transaction.

The Show Center feature 140 is used to schedule and manage road shows 141. For example, a road show presentation or video may be scheduled for viewing by an invited audience. Invitees are given identification numbers or passwords to gain access to a Posting at pre-specified times and view the road show materials.

Secondary Trade

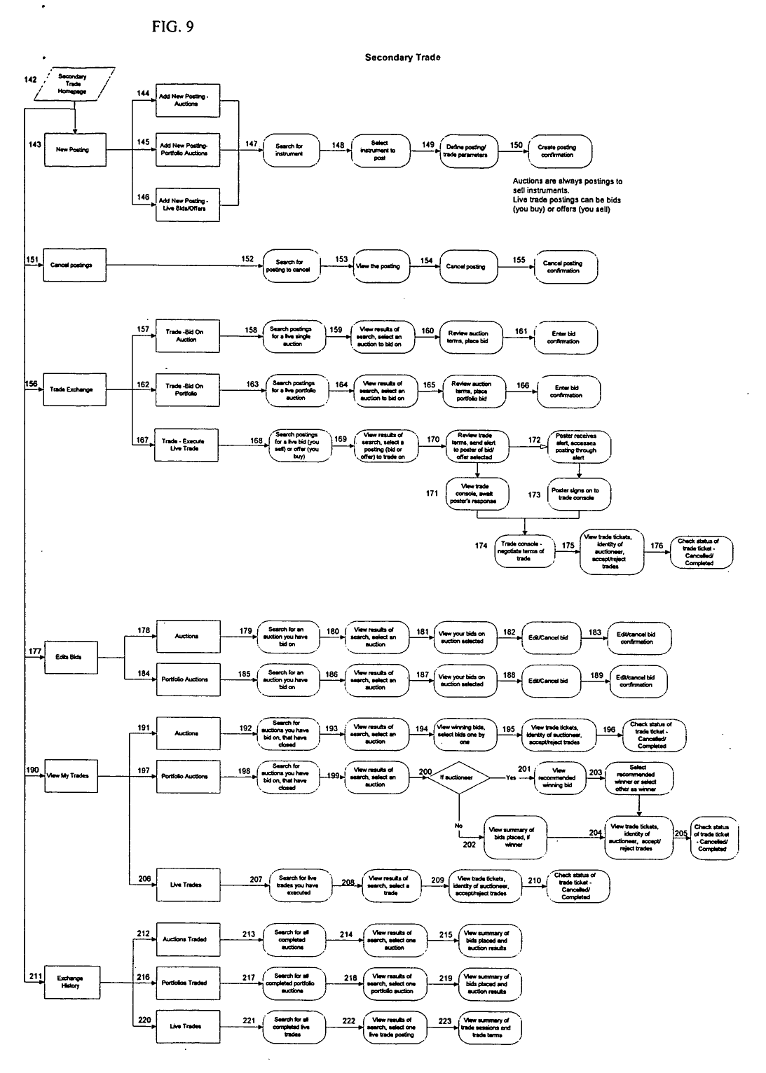

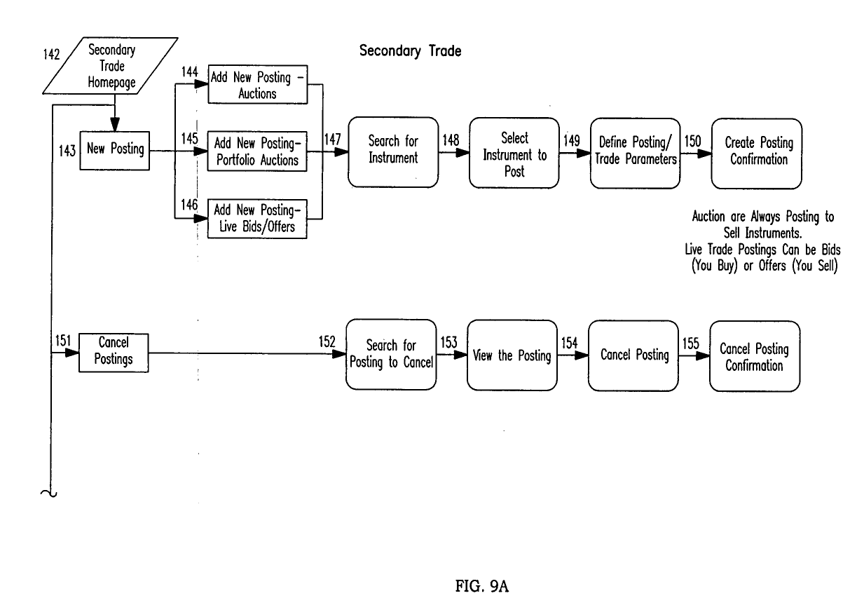

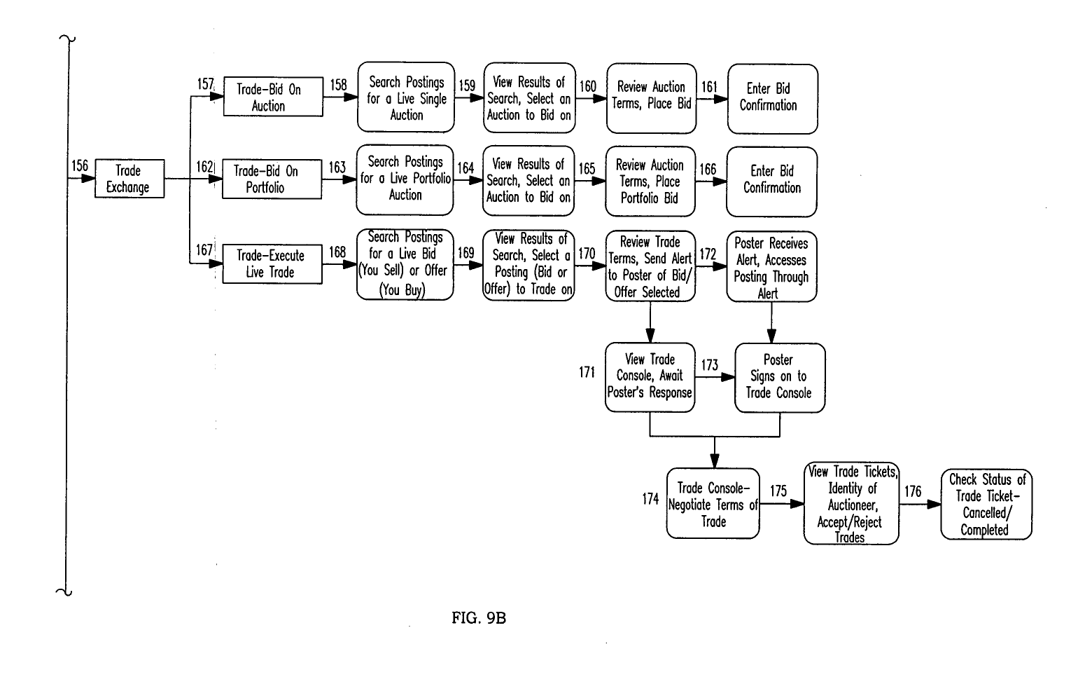

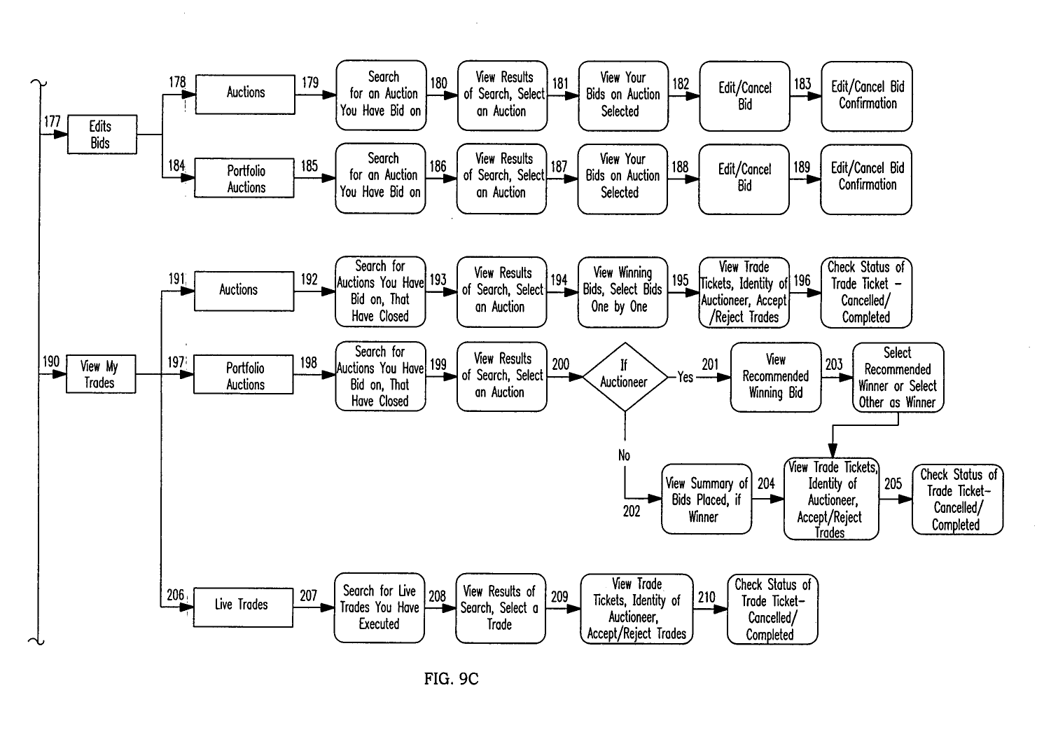

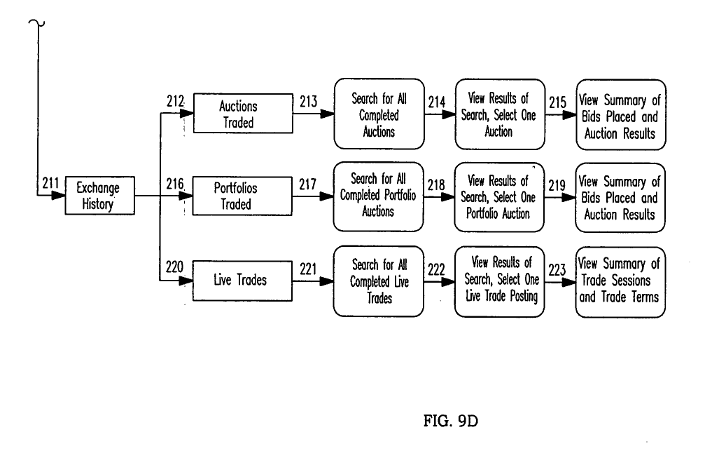

The flowchart of FIG. 9 shows how secondary instruments are traded in the system of the present invention. Information on instruments traded through the system is stored in a database of secondary instruments. By accessing the system through a website 142 and using the New Posting feature 143, a user may create: (i) a New Posting of a single instrument for auction 144; (ii) a portfolio of instruments for auction 145; (iii) or a New Posting for trade of live bids and offers 146. The user searches 147 the system by setting specific criteria for an existing instrument to post. From the search results, an instrument to post is selected 148. The auction or trade parameters are defined 149, such as: the type of auction (e.g., Dutch or straight); the offer amount; required bid prices; time of auction close; and settlement date for the trade. Once parameters are defined, then the user may post the New Posting 150. A confirmation of the posting is generated 150.

The Cancel Postings feature 151 is used to cancel a New Posting at any time. A user searches 152 for the posting to cancel by specified search criteria, selects and views the posting 153, and cancels the posting 154. A confirmation of the cancellation of the posting is generated 155 and sent to the user.

The Trade Exchange feature 156 allows a user to bid on an auction of a single instrument 157, bid on a portfolio of instruments 162 or execute a live trade 167.
a. Auction of One Instrument

A user can create a New Posting of a single instrument to trade by auction 144. A user defines the criteria to search for available auctions in order to submit a bid 158, and views the search result 159. The user selects an auction 159 to review more detailed information on that auction 160 (e.g., the amount being auctioned, any bid price/amount restrictions and the time of close of the auction). Interested bidders browse a bulletin board of current single auctions, find the instrument they would like to buy, and place bids on an auction. Bids consist of an amount and a price, both of which are validated against the Auctioneer's restrictions and the instrument's denomination requirements. After reviewing the details of an auction 160, a user may submit a bid 161. Bidders may place any number of bids on a current auction and also change or cancel bids. Auctioneers can cancel an auction before the auction close time. At the close of the auction, winning bids are determined and pending trade tickets are generated. The Auctioneer and the winning bidders review the trade ticket details, the counter-party's identity and decide whether to accept or reject the trade. Counter-parties could take up to one business day to decide whether to complete the trade, after running credit checks or trading limit checks if required. Determination of winning bids is done as follows: all bids are sorted in descending order of price and the highest bids are filled to the extent of the bid amounts. When the amount on Auction is not enough to fill the last winning bid, only a partial fill is given. In the case of several bids at the same price, the remaining Auction amount is divided pro-rata among the bids, and rounding of bid amounts is in favor of bids placed first. The fill prices could either be the respective bid prices (“straight” Auction) or the lowest fill price (“Dutch” Auction).
b. Auction of Portfolio of Instruments

A user may also post a portfolio of instruments 145, of any one currency and type for auction (e.g., bonds and loans may not be contained within the same portfolio of instruments). Similar to the auction of a single instrument, a user searches 163 the system for available auctions for a portfolio of instruments. The user views the search results and selects an auction to bid upon 164. The user reviews the details or terms of the auction 165, such as bid restrictions and time of close of auction, and, if interested, places a bid 166 (one per company or firm) on price only—the amount of each instrument is considered the offer amount. At the close of the auction, all bids are sorted by total bid values and the highest one is the “recommended” winner. The Auctioneer (or the seller of the portfolio or instrument) can accept the recommended winner or decide to select a lower bid to be the winner. A rejected bid cannot be later selected to be the winner. As in the single auction process, bidders may change or cancel bids and Auctioneers can cancel auctions, all before the close of the auction. The process of accepting and rejecting trades and settlement is the same as in single auctions. Auction winners are obliged to trade the entire Portfolio.
c. Live Trades

Single instruments can be traded in real-time using the Live Trade feature. A user creates and posts an instrument to buy/sell 146 (“Live Trade Posting”), along with details 149, including expected trade amount, price and trading times. An Interested counter-party (“Requester”) searches 168 and views 169 a list of current Live Trade Postings. The Requester reviews the terms or details of the trade 170 and selects the Live Trade Posting it wishes to participate in by sending a message to the Poster. The Poster receives a message or alert 172. The Requester awaits the Poster's response 171. The Poster logs in 173 and, once both the Poster and Requester are logged in, negotiate terms of the trade 174 (e.g., price, amount and settlement date) in real-time. Once the terms of the trade are finalized, the identities of the counter-parties are exchanged 175 and a user then decides to accept or reject the trade 175, just as in the single auctions. The user may then check the status of the trade 176 (e.g., canceled or completed) by accessing the system's View My Trades feature 190.

The Edit Bids 177 function provides the user with the ability to modify or cancel pending bids. Whether the bid is on an auction for a single instrument 178 or a portfolio of instruments 184, a user may search for the auction it has a bid on 179, 185; and, from the results of the search, the user may select the auction 180, 186 and view the user's bid 181, 187. The user can then edit or cancel the bid 182, 188. A confirmation that the bid was edited or canceled is generated 183, 189 and sent to the user.

View My Trades 190 monitors the status of auctions (both open and closed) 191, 197 or of trades a user has executed 206. Through this feature, a user may search for the auction or trade 192, 198, 207 and select the auction 193, 199 or trade 208 from the search result. For a single instrument auction, a user may review-winning bids 194; trade tickets, the identity of the auctioneer; accepted and rejected trades 195; and the status of open trade tickets (e.g., whether canceled or completed) 196. For a portfolio auction, if the user 200 is the auctioneer, then the user may view the recommended winning bid 201 and select either that bid or another bid as the winning bid 203. If, however, the user 200 is not the auctioneer, then the user can only view a summary of the bids placed 202. If the user 200 is either the auctioneer or not the auctioneer but has the winning bid, then that user may view the trade tickets, the identity of the auctioneer and the accepted and rejected bids 204. The user may also view the status of the trade tickets (e.g., canceled or completed) 205. For live trades, the user may view trade tickets, the identity of the auctioneer and accepted or rejected bids 209, and the status of the trade ticket (e.g., canceled or completed) 210.

Exchange History 211 allows the user to view information on all past executed auctions 212, 216 and trades 220. The user searches for all completed auctions 213, 217 or trades 221, and selects the auction 214, 218 or trade 222 that the user wishes to view. Exchange History allows the user to view information such as summary of bids placed and the auction results 215, 219 or a summary of trade sessions and trade terms 223.

Other Supporting Functions

d. My Account

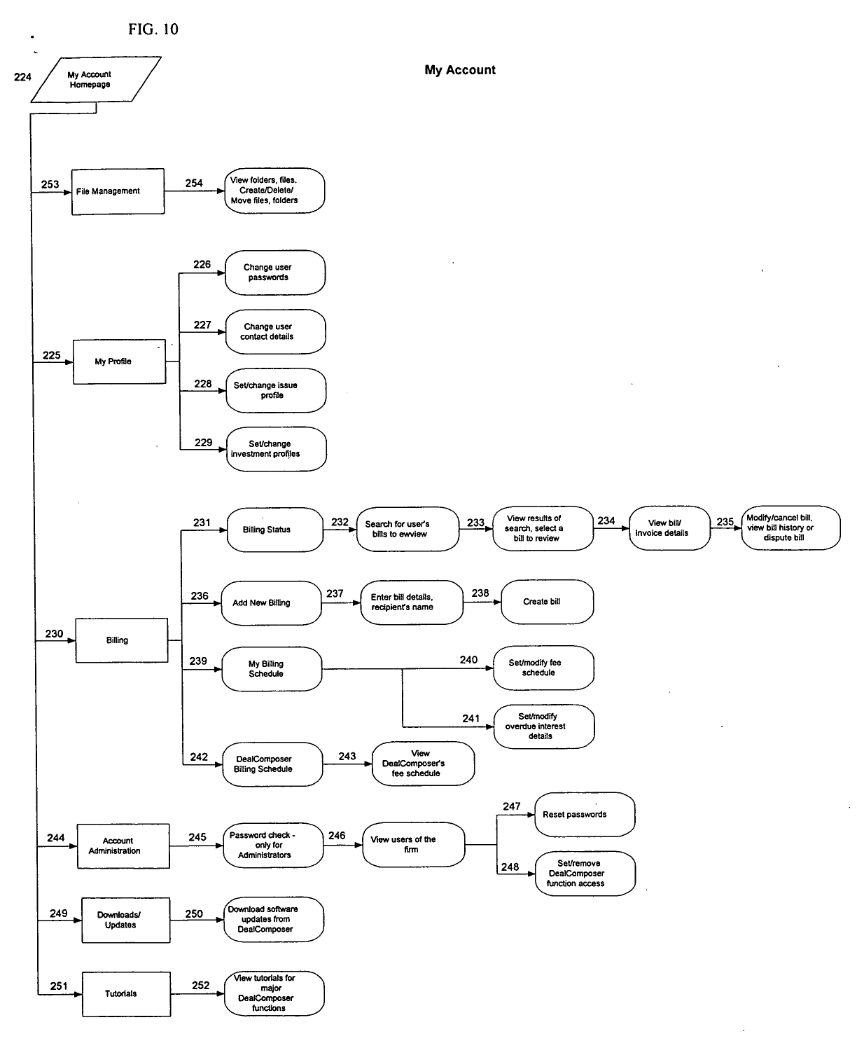

Turning now to FIG. 10. The My Account function 225, like the other functions, is initially accessed through a website 224. This particular function provides users with account related options or features to maintain the account on the system, such as the ability to change a password 226 and update contact information 227. This function allows a user to define and activate an Issue Profile 228 and Investment Profile 229 and to specify the types of transactions it would like to participate in, as defined by instrument type to issue or invest in, currency, maturity, etc. These profiles are compared to the Postings created in the Primary Trade, Secondary Trade and Interest functions and, if any of the Postings match the profiles, the user is sent a message or an alert. The message informs the user that a particular transaction matches their issuance or investment preferences and, if interested, to respond to the Posting. This feature in the My Portfolio function saves the user the time required to browse all the Postings created in each function.

The Billing feature 230 manages a user's billing requirements. Every completed primary and secondary transaction carries a charge 242. Financial Partners may maintain their own separate fee structure 239 for their customers. In addition to transactional fees, certain firms may charge clients for services rendered, such as valuation reports, due diligence reports and translations, for which invoices are generated. The Billing feature 230 handles both the automatic generation of bills for completed transactions and manual generation of invoices 238. The Billing feature 230 is comprised of four sections: (1) Billing Status 231; (2) Add New Billing 236; (3) My Billing Schedule 239; and (4) DealComposer Billing Schedule 242.

In Billing Status 231, a user may search 232 for bills, view the search results 233, and review the details of the bills 234 to monitor all bills receivable and payable. Bill amounts may be modified, canceled, disputed and due dates may also be modified 235. The payer and payee can negotiate the payment of bills in dispute through a messaging function. Add New Billing 236 creates invoices 238 to send to customers that contain information specified by the user 237, such as bill amount, due date and overdue interest rate. In My Billing Schedule 239, a user defines a fee schedule, overdue interest rate and the types of transactions that require the user's payment. A user may modify or set such Billing Schedule 240, 241. My Billing Schedule 239 also may define transactions for which users would like automatic generation of bills to be sent to customers. The schedule requires users to identify transaction types e.g., primary transactions, deal fees, advisory fees, etc., instrument types (e.g., bonds, loans etc.), fee amounts/percentages and overdue interest rates. When a transaction meets these criteria, a bill is automatically generated and sent to the appropriate paying parties.

Each user designates internally an authorized systems administrator. Only the user's authorized administrator is given access to the Account Administration 244 by a security mechanism such as a password system 245. The Account Administration function allows the user's authorized systems administrator to carry out certain basic account maintenance functions for other individual users within the firm 246; such as, resetting passwords 247, modifying user authorizations for various functions 248 and disabling users within the firm from accessing the system altogether 248. Only one member of each firm is given administrator privileges.

The Download/Update 249 feature gives a user the ability to download software applications 250 that may be required to facilitate or enhance the existing system's functionality.

The Tutorials feature 251 provides extensive directional assistance and specific tutorials to assist users. Help files are context sensitive; that is each page has a “help” hyperlink that takes the user to a pop-up window 252 with an explanation of what's on that particular page. In addition, each major function has tutorials that guide a user through the typical workflow paths to achieve the objectives of each function.

File Management 253 assists the user to manage its files by allowing a user to view files, organize, create, delete and move files and folders 254.

Alerts

Messages or alerts play a significant role in the system. As an Internet platform, transactions require that all participants be on-line and logged into the website simultaneously. Alerts are used to inform and remind users of actions required to carry each transaction toward completion. Alerts are generated by the system, that is, they are sent to users from the system and not from other users. Alerts are accessible from all functions in the system and an Alert Log button flashes when new Alerts are received. The Alert Log is arranged by function and all Alerts are stored until deleted by the user, in the order they were received. Given the requirements of each function, Alerts are mainly used in functions where multiple parties need to collaborate (Document, Due Diligence, Primary trade) or when timely confirmations are required (Secondary Trade, to confirm trade statuses, bid on Auctions etc.). In order to increase the effectiveness of Alerts as a means of timely communication, the My Account function as described (above) provides a separate Messenger feature. The Messenger feature automatically connects to the Internet when the connection is available, and checks for Alerts for the particular user. The Messenger creates a flashing desktop “icon” that monitors the Alerts even without the user launching a browser and logging into the website.

Partners

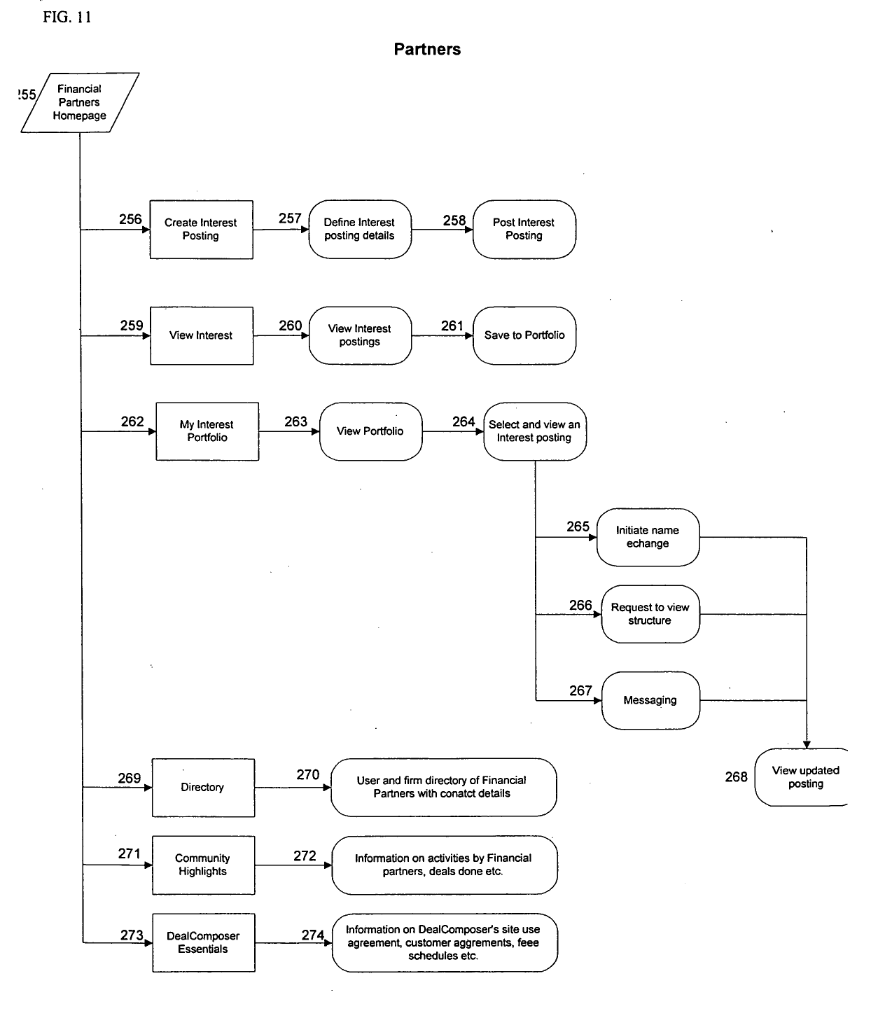

Considering FIG. 11, the Partners function is for the Community of Partners to use and works like the Interest function. In this feature, a user may create an Interest Posting 256 for transactions it is arranging or helping to execute or solicit other partners to play different roles in the deals. As in the Interest function, the user enters specifications into an Interest Posting 257, 258. The Interest Posting may be anonymous and targeted at specific types of Partners. A Financial Interest Posting can also carry structure diagrams and details of the transaction. Interested participants can request permission to view structures, request the exchange of identities and use the messaging system to obtain more information on the deal.

In View Interest 259, a user can view available Interest Postings 260, select a posting and save 261 it to the user's My Interest Portfolio. A user may subsequently access the Interest Posting through My Interest Portfolio 262. In My Interest Portfolio 262, a user may view 263 a listing of Interest Postings and select a particular Interest Posting for viewing 264. The user then has the option to initiate an exchange of identities or names 265, request to view a structure 266 or send a message 267 to the user maintaining the Interest Posting, and view the updated posting 268.

The Directory feature 269 provides a user and firm directory of all Partners 270 containing information such as contact numbers to help identify and contact suitable participants in any transaction. Community Highlights 271 provides a bulletin board of information 272 on activities of the Partners to keep all Partners updated. In DealComposer Essentials 273, the system further provides a user with reference information and links to other sites with helpful information 274 such as information about new features and releases, tutorials, contact information etc.

Communicate

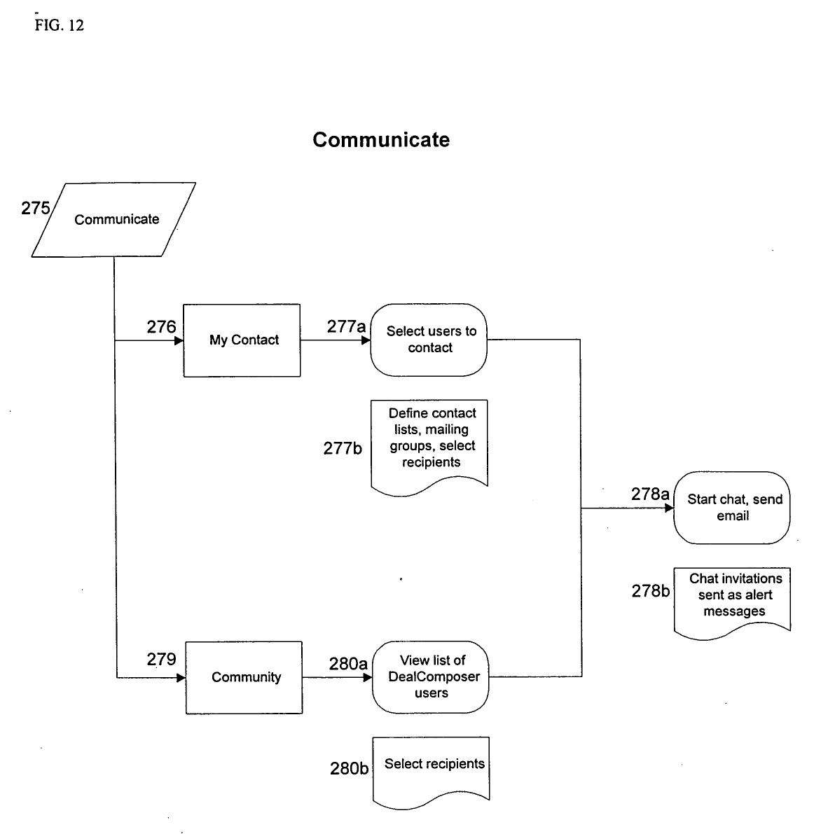

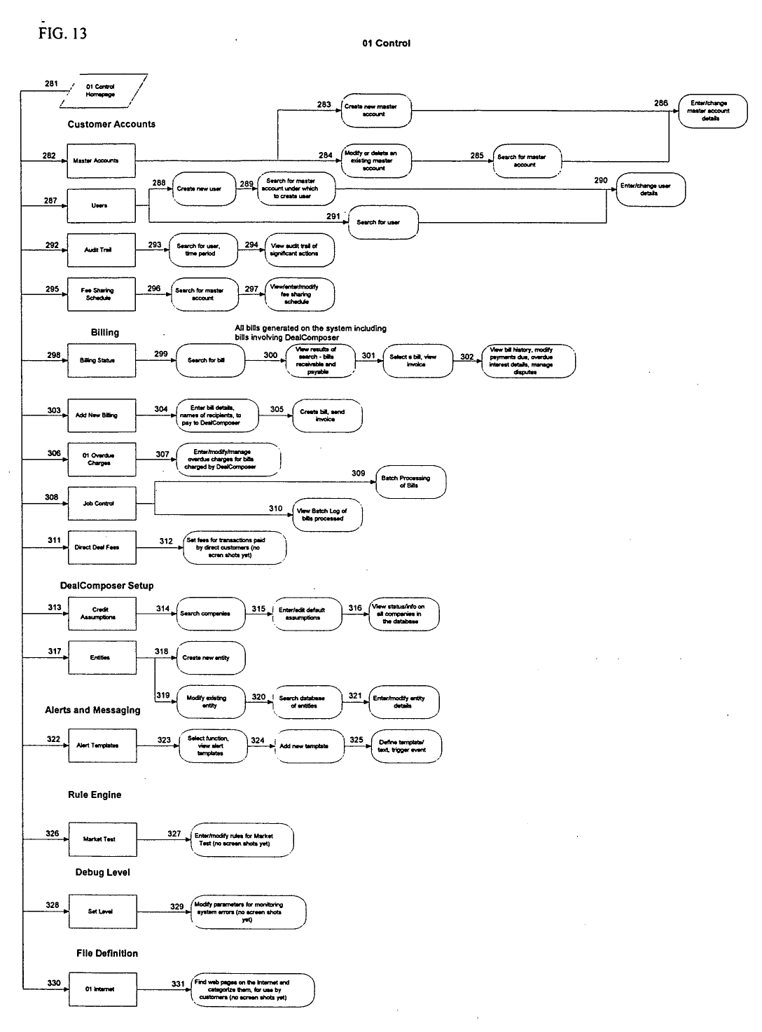

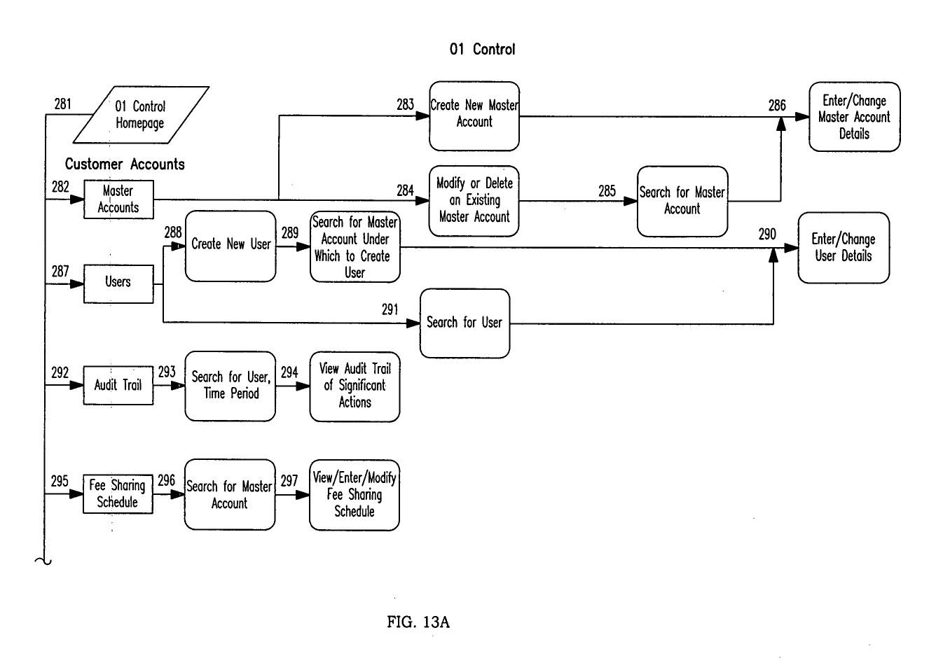

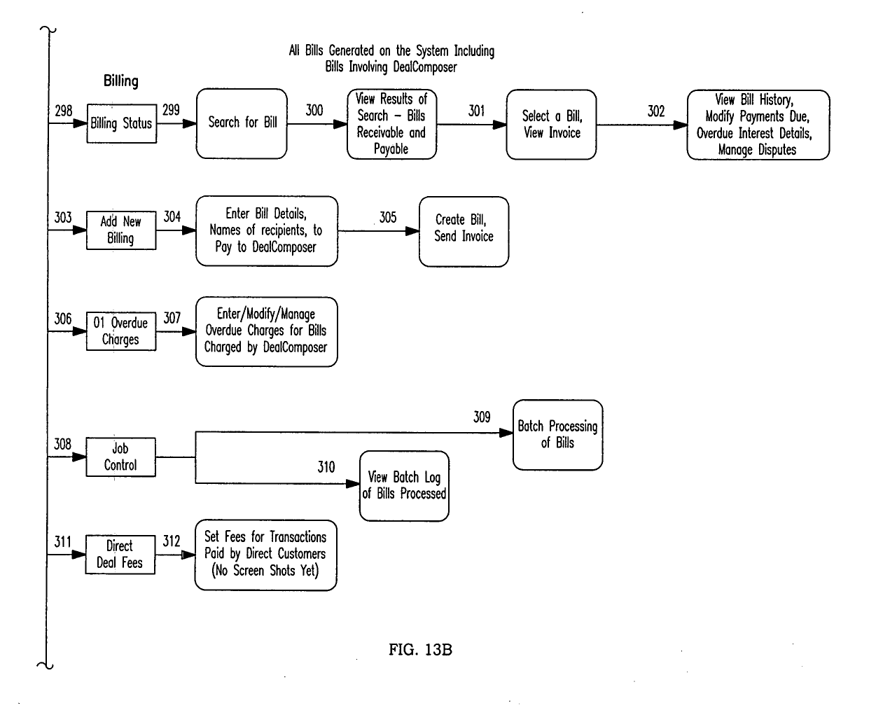

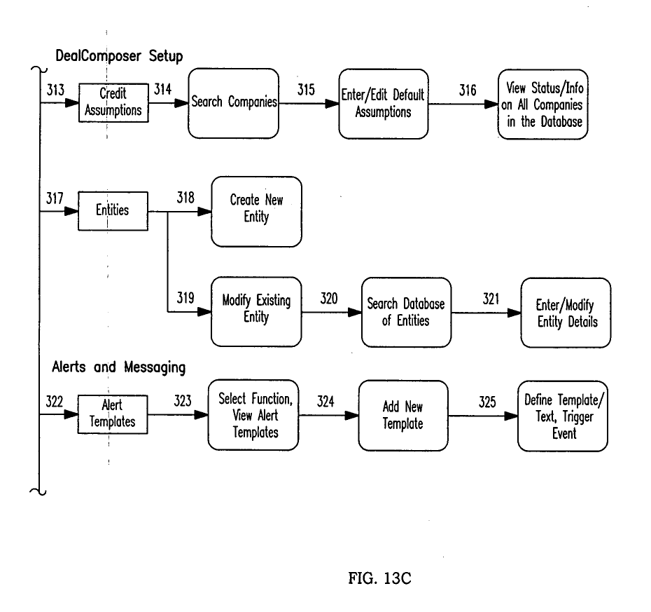

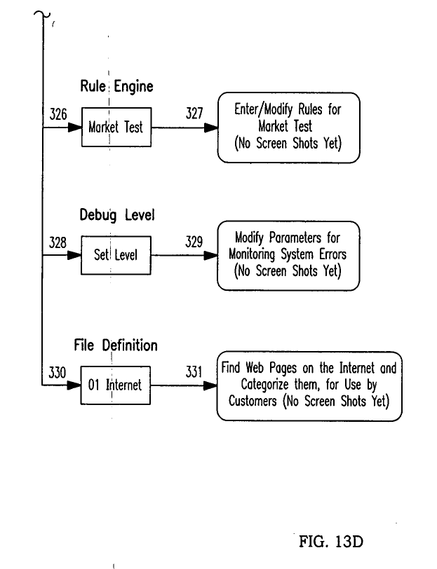

FIG. 12 depicts how users communicate in the present system. Accessed through a website 275, the Communicate function allows users to interact with one another when structuring a new deal or completing work in progress that needs the input of several parties. My Contact 276 facilitates user interaction by assisting a user to manage the user's contact information. From the user's contact information, the other user or users to be contacted are selected 277a. For example, the user's contact information may be defined and organized by mailing groups 277b. In Community 279, users are able to view a list of other users of the system 280a (e.g., sorted by company name and user name) and select the user or users to be contacted or recipients of a mailing 280b. Using the Live Chat 278a console, the user or users can simultaneously send messages in real-time and “chat” with one another. An email function 278b can be used to send messages or invitations to other users.

Technical Specifications

The general architectural elements of the invention's system are: (1) client systems; (2) a load balancing mechanism; (3) cloned front-end systems (that client systems access); and (4) partitioned back-end systems (that front-end systems access for persistent storage). Important architectural considerations are disaster tolerance and security domains. Objectives of the system's architecture include: linear scalability—continuous growth to meet user demand and business complexity; continuous service availability—using redundancy and functional specialization to contain faults; security of data and infrastructure—protecting data and infrastructure from malicious attacks or theft; and ease and completeness of management—ensuring that operations can match growth.

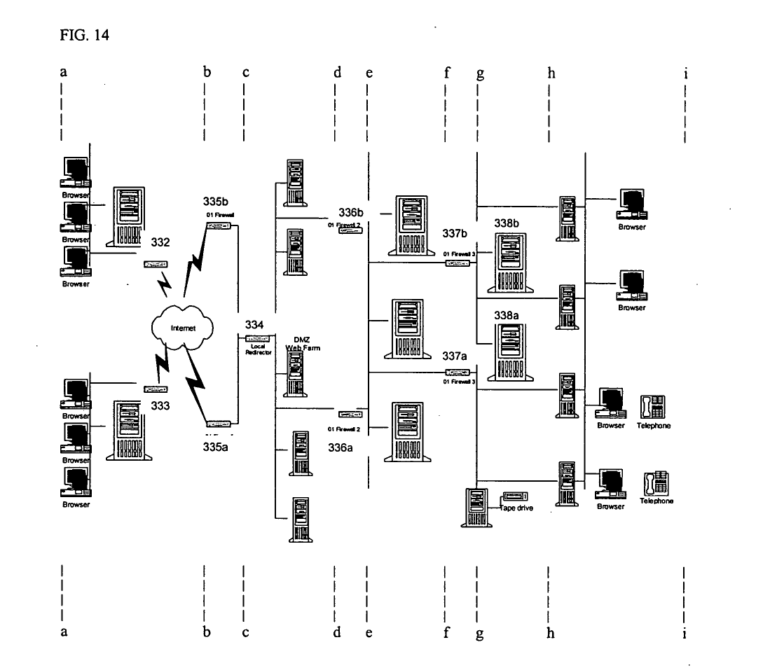

FIG. 14 is a layout diagram of the system of the present invention. The architecture is partitioned into four parts: (1) front-end (client-accessible) systems aa-bb; (2) middle-end systems bb-dd; (3) back-end systems dd-hh where long-term persistent data are stored or where business-processing systems are located; and (4) office operation where internal staff may operate the system from a secured environment. The load-balancing mechanism 334 is used to distribute the work across systems at the middle-end systems, and JNDI (directory service) located on Web Logic Servers is used to distribute works among the back-end systems. Front and middle-end systems aa-dd do not hold long-term state. That is, the per-request context in front and middle-end systems is temporary. This architecture scales the number of unique users supported by cloning or replicating front and middle-end systems aa-dd coupled with a stateless load-balancing system 334 to spread the load across the available clones. A set of Apache servers in a clone set is located on a Web Farm. Partitioning the online content across multiple back-end systems allows it to scale as well. An Application Server directory (e.g., Web Logic JNDI service) load-balancing mechanism ee-ff routes requests to the correct back-end systems dd-hh. Business logic complexity is increased according to functional specialization. Specific servers are dedicated to task-specific services, including integration with third party systems. Cloning and partitioning, along with functionally specialized services, enable these systems to have an exceptional degree of scalability by growing each service independently.

Middle-end systems bb-dd are made highly available as well as scaleable through using multiple, cloned servers, all offering a single address to their clients. Layer 4 switches 334 provide load balancing to distribute load across the Web Farm. A clone that no longer offers a service can be automatically removed from the load-balance set while the remaining clones continue to offer the service.

Back-end systems dd-hh are more challenging to make highly available, primarily due to the data or state they maintain. They are made highly available by using failover clustering for each partition. Failover clustering assumes that an application can resume on another computer that has been given access to the failed systems disk subsystem. Partition failover occurs when the primary node supporting requests to the partition fails and requests to the partition automatically switch to a secondary node. The secondary node must have access to the same data storage, which should also be replicated, as the failed node. A replica can also increase the availability of a site by being available at a remote geographic location. The Application Server provides transparent back-end failover and replication services.

Security (e.g., managing risks by providing adequate protections for the confidentiality, privacy, integrity, and availability of information) is essential to any website success. Firewall and network segmentation are key security elements. The system of the invention uses multiple security domains, where systems with different security needs are placed and each domain is protected by firewall 335, 336, 337. The three principal domains, each separated by a firewall are: the public network aa-bb, a DMZ (derived from the military term, “demilitarized zone”) cc-dd where front ends and content servers are placed and a secure network ee-ff where content is created or staged and secure data is managed and stored.

Management and operations broadly refers to the infrastructure, tools, and staff of administrators and technicians needed to maintain the health of a business site and its services. Due to the fact that the system of the present invention is a highly secured financial site, all equipment is located in secured rooms. The systems are monitored continuously and supported by duplicated Internet Service Provider connections to eliminate single point of failure. The management and monitoring of the systems can be done remotely.

The end user and the client software have no knowledge about the inner working of the system that delivers the service. The end user types the first URL, http://www.dealcomposer.com, and then either clicks on hyperlinks or completes forms on World Wide Web (“Web”) pages to navigate deeper into the site.

For a website with a very broad reach, an important decision is whether to support the lowest common set of features in browsers or whether to deliver different content to different browser versions. For example, the invention supports Microsoft's Internet Explorer versions 4.0 and later.

Middle-end systems bb-dd are the collection of servers that provide the core Web services, such as HTTP/HTTPS, LDAP, and FTP, to Web clients. Developers usually group these middle-end systems into sets of identical systems called clones. They all run the same Apache Web server and have access through content replication to the same Web content, HTML files, Java Server Page (“JSP”) scripts, and so forth. Layer 4 switches provide load-balancing requests across the set of clones, and by detecting the failure of a clone and removing it from the set of working clones, very high degrees of scalability and availability can be achieved.

Cloning is one way to add processing power, network bandwidth, and storage bandwidth to a website. Because each clone replicates the storage locally, all updates must be applied to all clones. However, coupled with load balancing, failure detection, and the elimination of client state, clones are an excellent way to both scale a site and increase its availability.

The middle-end load-balancing tier presents a single service name to clients and distributes the client load across multiple Web servers. This provides availability, scalability, and some degree of manageability for the set of servers.

The invention uses two principal ways to maintain client state across sessions. One is to store client state in a partitioned back-end server (WorkFlow stateful Enterprise Java Bean (“EJB”). Second is to maintain client state across sessions by keeping a temporary copy of the WorkFlow reference on the Web Server for performance reason. Each piece of stateful information is associated with client session via the use of cookies. Cookies are small files managed by the client's Web browser.

Back-end systems are the data stores that maintain the application data or enable connectivity to other systems, which maintain data resources. The invention's system data may be stored for example, on Oracle database systems. Back-end systems are more challenging to scale and make highly available, primarily due to the data and state they must maintain. Once the scalability of a single system is reached, for example, it is necessary to partition the data and use multiple servers. Continuous scalability is therefore achieved through data partitioning and a data-dependent routing layer or a stateful load-balancing system, which maps theological data onto the correct physical partition.

For increased availability, the invention supports clustering, which typically consists of more than one node (e.g., available from a hardware vendor such as SUN) with access to common, replicated, or Redundant Array of Independent Disks (“RAID”) protected storage. If the service on one node fails, the other node takes over the partition and offers the service.

Partitions grow a service by replicating the hardware and software and by dividing the data among the nodes. In the present invention, data is partitioned by object, such as deals, customer accounts, and postings. It is also possible to distribute objects to partitions randomly. The Application Server provides the capability to split and merge partitions online (without service interruption) as demands on the system change. Increasing the number of servers hosting the partitions increases the scalability of the service. Partition failover, a situation in which services automatically switch to the secondary node (rolling back uncommitted transactions), provides the Application Server with continuous partition availability.

When data is partitioned across a number of data servers, or functionally specialized servers have been developed to process specific types of Web requests, the Application Server routes the request to the appropriate data partition or specialized server.

In addition to using failover and clustering to achieve high availability, an important consideration in the overall system architecture is the ability of a site to offer some limited degree of service, even in the face of multiple service failures. The invention's system is designed to provide multiple locations where user accounts are replicated, and service can be maintained for example, even though two out of three locations are out of service.

Some business websites require continuous service availability, even in the face of a disaster. Their global business depends on the service being available. Disasters can either be natural—earthquake, fire, or flood—or may result from malicious acts such as terrorism or an employee with a grudge. Disaster-tolerant systems require that replicas or partial replicas of a site be located sufficiently far away from the primary site so that the probability of more than one site being lost through a disaster is acceptably small. The invention uses multiple sites (e.g., Asia, Europe, and North America) to provide continuous coverage. In order to keep replicated sites up-to-date with consistent content, the basic methodology used is to replicate the content from central staging servers to staging servers at the remote sites, which update the live content on each site. For read-only content this method is sufficient. However, for more sophisticated sites where transactions are executed, it is also necessary to keep the databases up to date. One embodiment of the invention adopts a single site update and replicate approach to resolve the database synchronization problem. Database replication and log shipping is used where transactional updates to the central database are shipped to a remote site. Typically, the databases will be several minutes out of synchronization. However, this is preferable to the complete loss of a site. In the case of the central site outage, one of the read-only sites will be elected to become the update site until the central site recovers.

Security mechanisms protect the privacy and confidentiality of sensitive information from unauthorized disclosure. These mechanisms protect system and data integrity by preventing unauthorized modification or destruction and help ensure availability through prevention of denial-of-service attacks and by providing contingency or disaster planning. Security domains are regions of consistent security, with well-defined and protected interfaces between them. Application of this concept can help to ensure the right levels of protection are applied in the right places. The invention's system may be partitioned into multiple security domains. For example, the security domains may consist of: Rending Layer, WorkFlow Layer, Business Logic Layer, and Database Layer. The Rending Layer lies inside the DMZ behind the first layer of Firewall. WorkFlow and Business Logic layers located behind the second layer of Firewalls and protected by Access Control List. Database lies behind a third layer of Firewall and is only accessible from Business Logic Application Server.

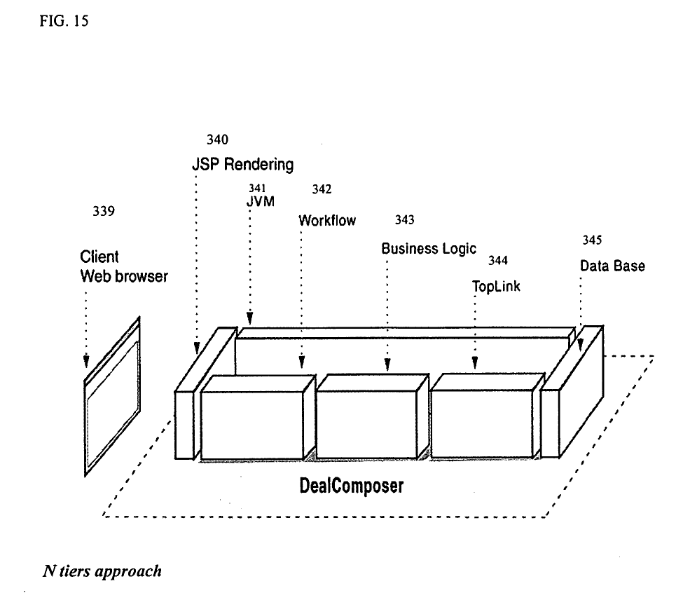

Turning now to FIG. 15, the system of the invention is implemented in N tiers: Rendering 340, Workflow 342, Business Logic 343, and Database 345 (includes Toplink 344 “Object to Relation mapping”). Briefly, Rendering Layer 340 is a presentation, or user interface layer, that contains the knowledge of how to interface with the specific device that the user is using to communicate with the system. Workflow Layer 342 is logic that coordinates smaller pieces of work to accomplish a larger, more complex task. Business Logic Layer 343 is a layer that contains the business rules of how the user interacts with and manipulates the data in the Database Layer 345. Database Layer 345 is layer where the physical storage of all data is kept.

The Rendering Layer 340 is comprised of the user interface and technology-specific logic that maps the user interface (“UI”) to the workflow layer. Rendering logic 340 translates user input such as a mouse click or a keystroke, into a workflow method such as adding a Primary Trade Deal Structure to a Posting. In the other direction, Workflow logic 343 delivers contents to the Rendering Layer 340 in a Form Object (primitive form of Extensible Markup Language (“XML”). The Rendering Logic 340 is responsible for converting the data into whatever physical delivery media that the end user is associated with (such as voice-over phone, HTTP text over internet).

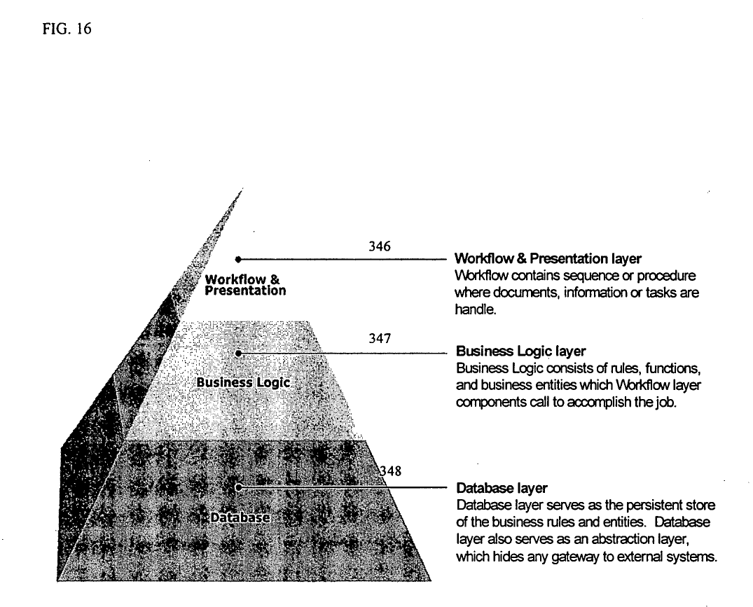

Workflow 343 is logic that coordinates smaller pieces of work to accomplish a larger, more complex task. Workflow logic 343 differs from transactional logic in its tolerance for incomplete work. A transaction seeks to be either complete, where all pieces of work become permanent, or completely undone. Workflow logic 343 allows many sessions to remain at an incomplete state for a comparably long period of time without incurring significant overhead. FIG. 16 shows the logical Workflow layer with the Presentation and Business logic application layers. On the client-side of the Workflow layer is the Presentation layer, which contains logic specific to a presentation technology. On the server-side of the Workflow layer is the Business logic layer, which simplifies business transactions.

In the system of the invention, the Workflow Layer (“WFL”) is stateful, which means that it holds data between method calls. The stateful WFL accumulates contextual data (or state) and executes methods on the Business Logic Layer (“BLL”). The BLL can be either stateful or stateless. The stateless BLL design simplifies resource sharing and promotes scalability by allowing a single BLL instance to be shared by multiple WFL instances without restoring context for each instance. BLL servers may employ load balancing or resource pooling to achieve scalability. The stateful BLL is less desirable but sometime necessary for complex and nested objects.

The stateful workflow layer works with the mostly stateless BLL to achieve important scalability and usability advantages. The WFL does its transactional work through the BLL and effectively releases BLL instances between method calls. Because the transactional resources are acquired through the BLL, the number of open transactional resources does not grow directly with the number of simultaneous workflow instances. This decoupling between layers allows the application to use resources effectively.

The BLL simplifies business transactions so that workflow code does not have to be concerned with implementation details. This allows workflow code to execute transactions, like get Primary Issue Events, without concern for implementation details beyond the BLL interface. The BLL will either execute the transaction and report success or it will fail and report the reason to the WFL.

The system uses three layers of data caching:

1. Toplink to perform object to relation mapping and controls use of a cache to enhance application scalability and usability. Use of a cache at the BLL level eliminates redundant trips to the back-end database to fetch infrequently changing data. Caching enhances usability by shortening the response lag as the user navigates through the application;
2. Workflow to store frequently used Objects and eliminates repeated instantiation of object at the Toplink layer; and
3. Web Server to temporary stores Form Object returned by WFL in HTTP session space. Use of cache at the Rendering Layer eliminates redundant trips to the WFL and redundant formatting of that data for the Rendering Layer. In addition, data that is cached in the Rendering Layer in a format that can easily provide twenty times the performance of an application that retrieves data from the database and formats that data on each request. In the system of the invention this performance gain is effectively multiplied because it speeds up Deal and Portfolio browsing, which is a statistically large proportion of total server requests.

DealComposer uses Oracle as database.

The system of the invention uses the latest architectural approach to the system design, and the entire system is decomposed into “packages” and documented in Unified Modeling Language (“UML”). UML focuses on the organization of the actual software modules in the software-development environment. The software is packaged in small chunks (program libraries or subsystems), called “packages” that can be developed by one or more developers. The packages are organized in a hierarchy of layers, each layer providing a narrow and well-defined interface to the layers above it.

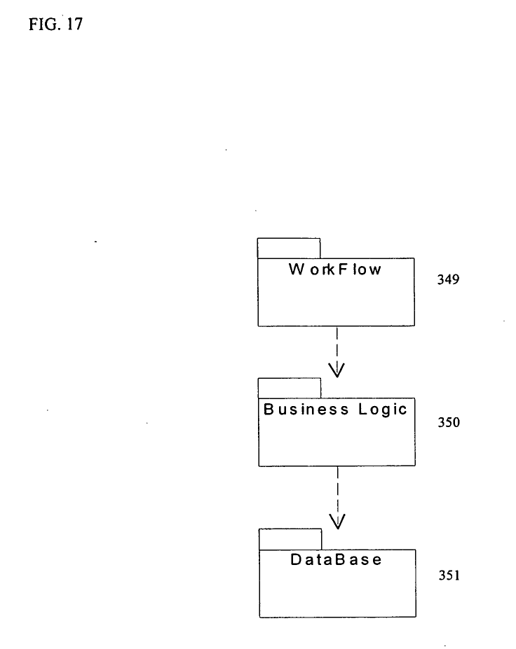

Turning to FIG. 17, in one embodiment of the invention, the packages are divided into Rendering, Workflow 349, and Business Logic 350 layer. As described in the previous section, Rendering Layer packages contain all the logic in JHTMLs and JSPs, which converts data into HTML data stream. Workflow packages 349 contain logics that coordinate smaller pieces of work to accomplish a larger, more complex task. Business Logic packages 350 contain codes that conduct the actual business transactions. Most of the WFL package 349 has corresponding Rendering Layer package, and all share services provided by the BLL packages 350. The following section explains the function provided by each major package and their corresponding layer.

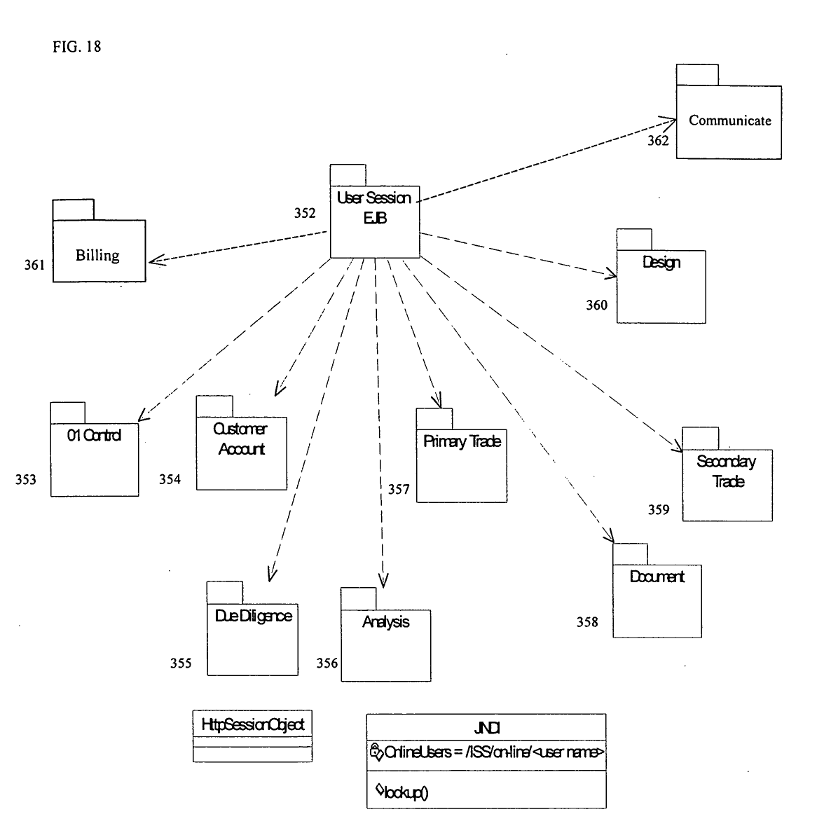

FIG. 18 illustrates the WFL packages of an embodiment of the invention. The function of the 01 Control Package 353 comprises: Account Maintenance which manages user attributes from Customer Account BLL; Billing which manages Billing attributes BLL; and Administrator functions which manages attributes of Master Account from Customer Account BLL. The Master Account is a system account for an entity where there may be sub-accounts for other users.

The Billing Package 361 comprises Billing WFL, which consists of several components including: Billing Manager, which manages all the activities inside the Billing Package; Bill Agent, which executes billing requests from other packages; and Batch Process, which invokes the Calculation Engine to calculate fees or outstanding balances.

The Communicate Package 362 allows a user to interact with one another when structuring new deals or completing work in progress that needs the input of several parties. Communicate provides functions including: a Live Chat console that can be used by many users simultaneously to send messages in real-time and “chat” with one another; and an email function (Email from Alert BLL) that can be used to send messages to other users. Communicate also allows the user to create mailing groups and chat communities (Group from Customer Account BLL, communication address from Communication BLL). All users are able to see a listing of other users, sorted by company and user names.

The Credit Analytics Package 356 comprises Credit analysis WFL is an integral part of any financial transaction, including the capital raising process. It provides two major functions, a Calculator function and Insert Structure function.
a. Calculators

The Credit Analysis function is used to analyze the financial statements (Financial Statement object in Credit Analytics BLL) of companies (Legal Entity object in Customer Account BLL). The invention maintains a database of financial statements (balance sheets, income statements and cash flow statements, all from Credit Analytics BLL) of listed companies in several countries. A user can also project the past financial data for five years into the future. The projections are generated based on a set of “assumptions” (Assumption object in Credit Analytics BLL) that can be modified at any time. The assumption sets (Scenario object in Credit Analytics BLL) can be saved and retrieved from the file directory (Virtual File object in Customer Account BLL). Users can also analyze specific parameters using a set of calculators—for revenues, costs, leverage, profitability etc. (Calculation Engines in Credit Analytics BLL). These calculators take user inputs in the form of future assumptions (Assumption object in Credit Analytics BLL) and return specific numbers generated from financial statements.
b. Insert Structure

The Insert Structure function simulates the effect of a transaction on the financial statements of the issuer. The cash flows from a transaction are superimposed on to the projected financial statements of the issuer (Insert Structure Calculation Engines in Credit Analytics BLL). Users can then analyze the effect of the transaction on the profitability, leverage and cash flows of the issuer.

In the Design Package 360, Design WFL provides two main functions to the user.
a. Drawing Tool

The Drawing Tool is a graphical user interface used to create structure diagrams. A user (Customer Account BLL) is given a drawing “canvas” on which boxes and arrows can be placed. The boxes represent companies or legal entities (supported by Customer Account BLL) and the arrows represent financial instruments (an event, supported by Deal BLL).

Users can then define the attributes of the diagram elements—boxes and arrows are each associated with a pre-defined list of attributes in Customer Account BLL 354 and Deal BLL package. Clicking on the boxes launches the “entity attribute list” that covers most of the significant parameters that define a company—name, address, country of incorporation, industry type, rating and basic financial information (attributes of Customer Account User object). The arrows launch an “event attribute list” that covers instrument name, details of issuance, coupon, redemption, security, associated guarantees, options etc. (attributes of Deal objects). Once the boxes and arrows are defined users can “save” the structure to their file directory (Virtual File in Customer Account BLL package) for future use. Also available is a Deal Library (Virtual File in Customer Account BLL and Security BLL to restrict updates), which contains commonly used structure templates (supported by Deal BLL) that users can customize for particular transactions.
b. Test Structure

After creating structure diagrams, users may run tests including the three tests below to evaluate the viability of the structure and identify potential problems at the design stage itself
i. The Market Test

Supported by Rule Engine BLL, Market Test compares the attributes of the instruments in the structure (Deal BLL) against common market practices and prevalent conditions and recommends suitable changes to the structure. Rule Engine is the computer software that supports and executes the market, regulatory and tax tests.
ii. The Regulatory Test

Supported by Rule Engine BLL, Regulatory Test analyzes the instrument types in the structure (Deal BLL), the issuing/investing entities (Customer Account BLL 354) and compares them against the relevant securities and foreign exchange regulations in the jurisdictions involved (Rule Engine BLL). The Regulatory Test would then identify potential problems with the structure and recommend suitable solutions. This test draws from a proprietary database of regulations in various jurisdictions.
iii. The Tax Test

Supported by Rule Engine BLL, Tax Test is mainly used to highlight withholding tax implications of a structure. Given the instrument types and the countries of the entities involved in the transaction, the Tax Test informs users of the taxes applicable; so users can modify their structure to minimize their tax liability. This test uses a proprietary database (Rule Engine BLL) of tax laws.

Document Package 358 allows issuers and investors to collaborate and select law firms (Legal Entity from Customer Account BLL) to help draft transaction documents (Document BLL).
a. Creating Document Postings

Users can attach their draft documents (Document BLL 338) to a document “posting” (Posting BLL), which can be accessed by all the participants in the transaction (Document Posting Board extended from Posting Board BLL). Users define access authorizations (Security BLL) for the posting as a whole and each of the documents in the posting. Each participant (User from Customer Account BLL) can access the posting (Posting BLL) and play a role (Role from Customer Account BLL) and every participant receives updated information on the status (Email and Alert BLL) of each document and of the posting. The documents attached to a posting could come from a user's desktop computer or from a repository Content Management System (“CMS”) BLL. The repository is a storage area for documents, files and any materials that a user would require during the execution of a deal. The repository is accessible from the Document and Due Diligence functions. Also available from the Document function is a facility for requesting the translation of documents (Document BLL).
b. Selecting Law Firms

Financial transactions require law firms (Legal Entity from Customer Account BLL) to draft documents (Document BLL) and each participant in the deal usually consults a legal counsel before signing any legal documents. The invention's document function facilitates the selection of law firms through two methods. A user can also hold an auction (Auction in Document BLL extended from Auction BLL), on which law firms can bid—the lowest bid is selected as winner.
C. Drafting Legal Documents

All files and documents attached to a posting are accessible one user at a time. Files are checked out and checked in (supported by CMS BLL), one at a time and the latest version is available for review. This ensures that there is only one version of all documents and that all users are kept informed of document histories (when it was changed, by whom and current status). After documents have been finalized, authorized participants can send them to a checklist (Checklist from Document BLL).

The Due Diligence Package 355 provides three main functions.
a. Create Due Diligence Posting

A Due Diligence posting (DD Posting in DD BLL extended from Posting BLL), similar to a Document posting, helps collect the participants and materials to prepare all the supporting materials required to execute a transaction. These materials could include conventional due diligence reports such as research, offering memoranda or even business plans (DD BLL) for venture capital funding. The user creating the Due Diligence posting can grant access (Security BLL) to the other participants (User from Customer Account BLL), who are sent an alert and asked to participate in the posting.
b. Managing Due Diligence Materials

The Materials Library (CMS BLL) holds all the files uploaded for this transaction. Files can be added to the library from different pathways including: the user's desktop computer; the repository (CMS BLL) which stores all documents uploaded previously and from the Document function; a search engine (Web Crawler BLL) to find and retrieve relevant documents from the Internet; and Due Diligence templates (DD BLL) are customized for this transaction. As in the Document function, Due Diligence also provides for translation services. A user can send a file to a translation agent (Legal Entity from Customer Account BLL) signed on the DealComposer and request a translation.
c. Financial Builder

The Financial Builder function is engineered for start-ups (technology and manufacturing companies) seeking a first or second round of venture capital and users who may not have the expertise required to draft financial projections or business plans. To create a business plan (Business Plan object from DD BLL—to be built), users are guided through a “wizard” that asks several questions on the various aspects of their business—the type of company, the expected revenues, expected costs in terms of salaries and office expenses, expenses for manufacture or software development etc. Once the user provides the necessary information, the function calculates the expected cash balances at the end of the first five years to indicate the approximate capital or funding requirement (Business Plan Calculation Engine from DD BLL—to be build). Users can then decide on the amount and timing of the funding—either as equity capital or as debt.

The Financial Partners Package

The Financial Partners (Role in Customer Account BLL) function is for the community of Financial Partners (Group in Customer Account BLL) and works very much like the Interest function. Financial Partners can create interest postings (Posting BLL & Posting Board BLL) for transactions they arrange or help execute, soliciting participation from other Partners to play different roles in the deals. The Financial Partners function also provides for a bulletin board Posting Board BLL), to keep all Financial Partners updated on the transactions in progress. Also available on the platform is a directory of all Financial Partners (Directory object from Communication BLL) on the system to help identify and contact suitable participants in any transaction.

The Interest Package function allows users to browse through a library (Interest Posting Board from Posting Board BLL) of primary issuance posted (Interest Posting from Posting BLL, and Design Structure from Deal BLL) by other users (User from Customer Account BLL).
a. Creating Interest Postings

Users (Customer Account BLL) can create interest postings (Posting BLL) as the first step towards executing their transactions. The main purpose of an interest posting is to solicit responses from suitable and interested counter parties (Interest Profile from Interest BLL and Customer Account BLL) and participants (User from Customer Account BLL). An interest posting contains details of issuance or investment (attributes of Posting object in BLL). Users whose profiles match (Match Engine from Interest BLL) the details on any interest postings are alerted (Alert from Alert BLL) and can then access the postings (Security BLL) and contact the poster (Customer Account BLL) for further negotiation.
b. Community Interest Postings

The interest postings of the DealComposer community (Interest Posting Board BLL) are open to all users (User from Customer Account BLL, and Security BLL). Users find postings they would like to follow-up on can save these to their “portfolio” (Interest BLL). If a structure diagram (Deal object from Deal BLL) has been attached to the Interest postings (Posting BLL), interested counter parties can request permission to view the structure. In both the above cases, the poster can choose to accept or reject the requests (Alert BLL).

Primary Trade Package 357 provides several functions.
a. Creating Primary Trade Postings

Creating a primary trade (Primary Trade Posting extended from Posting BLL) posting is the first step in executing a transaction or issuing an instrument. Primary trade postings handle the issuance of an instrument through the syndication process. This type of posting also facilitates the issuance and distribution of an instrument through live auctions.

The Posting Manager (Role from Customer Account BLL) manages the issuance process; who owns (Security BLL) and manages the New Issue posting. The issuers of the instruments (Deal BLL) can choose to be Posting Managers themselves or invite Financial Partners (Legal Entity from Customer Account BLL) to manage the posting on their behalf Financial Partners who accept these invitations then create the posting for the issuer. Each New Issue posting contains several categories of information relevant to the transaction and facilitates several functions, grouped into four sections (attributes of Primary Trade Posting extended from Posting BLL)
b. Posting Details

Posting contains details of the transaction being executed, the instrument (Deal object Deal BLL) being issued, the deal schedule (Calendar object from Deal BLL for pre-syndication, syndication periods), links to the offering memorandum (DD BLL), supporting attachments like presentations (Document object from Document BLL), legal document presentations (Document object from Document BLL) and research presentations (Document object from Document BLL).
c. Deal Center

Deal Center is for communication between the Posting Manager, the syndicate and the end customers of the syndicate members (attributes of Posting). Deal Center includes workflow for inviting end customers and syndicate members, granting interested users permission (Security BLL) to participate in the transaction, a function to target certain types of customers and an email function.

d. Trade Center

Trade Center is for sending, receiving and managing orders (Order object from Primary Trade BLL), monitoring the status of each order and the status of the syndicate. Syndicate members (User Object) place orders (Order object from PT BLL) with the Posting Manager (User object) and end customers (User object) place orders with their respective syndicate members. Also available is a messaging function (Alert BLL) across syndicate and customer groups and a section displaying the members of the syndicate, their roles, their fees (Billing BLL) and the status (status management in Primary Trade BLL) of each of their participation in the transaction.
e. The Syndicate Process

The Syndicate process is carried out in three stages (State Management from Primary Trade BLL): pre-syndication; syndication and post-syndication. This stage is for syndicate members to finalize their customers' orders. At the end of the Post-syndication period, all syndicate members' and customers' orders are then confirmed by Allocation Tickets (Primary Trade BLL) and the status of the posting changes to “Closed” (State Management from PT BLL).

The Secondary Trade Package function facilitates the trading of secondary instruments (Deal object from Deal BLL) over the Internet. All trades terminate in the mutual exchange of identities of the buyer and seller (User from Customer Account BLL).
a. Auction of Single Instrument

Users (Customer Account) can “post” a single instrument (Secondary Posting from Posting BLL, and Posting Board BLL) for auction. The posting specifies the amount being auctioned, any bid price/amount restrictions enforced by the auctioneer and the time of close of the auction (attributes of Posting object from Posting BLL). Interested bidders (User object from Customer Account BLL) could browse a bulletin board (Posting Board BLL) of current single auctions, find the instrument they would like to buy and place bids (bid object from Posting BLL) on the auction. Bids consist of an amount and a price, both of which are validated against the auctioneer's restrictions and the instrument's denomination requirements (attributes of bid object). Bidders can place any number of bids on a current auction and also change or cancel bids. Auctioneers can cancel auctions before the auction close time.

At the close of the auction, winning bids are determined (auction executioner from Auction BLL) and “pending” trade tickets (trade ticket object from Trade BLL) are generated. The auctioneer and the winning bidders are required to review the trade ticket details, the counter party's identity and decide whether to accept or reject the trade. Counter parties could take up to one business day to decide whether to complete the trade, after running credit checks or trading limit checks if required.
b. Auction of Portfolio of Instruments

Users can also post a portfolio of instruments (portfolio object in Posting BLL) for auction. Interested buyers place bids (one per firm) on price only—the amount of each instrument is the offer amount. At the close of the auction, all bids are sorted by total bid values and the highest one is a “recommended” winner. The auctioneer can accept the recommended winner or decide to select a lower bid to be the winner. A rejected bid cannot be later selected to be the winner.
c. Live Trades

Single instruments can be traded in real-time using the Live Trade function. A user (“poster”) can post an instrument (Posting BLL and Posting Board BLL) to buy/sell, along with details of expected trade amount and price and trading times. An interested counter party (“requestor”) can browse the list of current Live Trade postings, select one and send an alert message (Alert BLL) to the poster. The poster and requestor then log in to a Trade Console that facilitates real-time trade between two entities allowing them to negotiate price, amount and settlement date in real time (Market Analytics BLL). Once the terms of the trade are finalized, the identities of the counter parties are exchanged. Users can then decide to accept or reject the trade, just as in single auctions.

Business Logic Layer

The Alert BLL Package is an end-to-end message delivery mechanism. Every user on the system has one Alert Box and messages in Alert Box are delivered to the user. The Alert BLL Package also supports formatted message, which can be modified via the 01Control functions. Alert BLL also provides formatted Email to double ensure that users who are not online will get Email notice.

Auction BLL Package provides “Auction Executioner object” and “Auction Rule object,” which is responsible for selecting winners when an auction time has reached.

Audit BLL Package provides audit object, which serves as the low level objects that WKL packages can call to record an event.

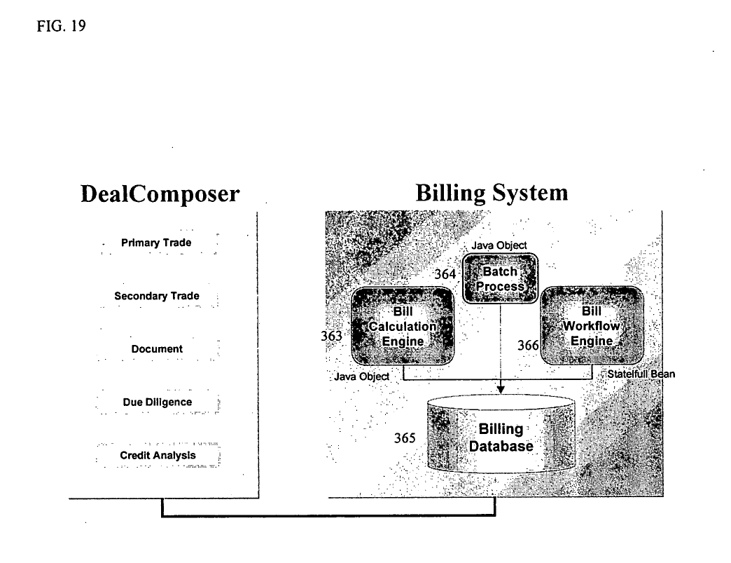

Considering FIG. 19, Billing BLL Package consists of several components: Bill Calculation Engine 362 responsible for calculating fees; Fee Scheme that represents the amount that each user is to get charged; Batch Process 364, which invokes the Bill Calculation Engine 363; Billing Database 365 that contains information relating to billing e.g., fee structures, payee information; and Bill Workflow Engine 366.

Content Management System BLL provides file level check-in and checkout facilities. By checking out a document, the system prevents other users from checking out the same document and modifies the content. It also provides for versions, historical remarks, and roll back mechanism.

Communicate BLL Package provides communication directory and address (e.g., on-line IP address) information to allow Communication Workflow to get in touch with Users.

Customer Account BLL Package supports the following major objects:

1. User, Group, Role, Master Account, Legal Entity, 01 Legal Entity, and Template. The User object is the single point of reference of everything related to a specific user or Legal Entity.

2. Function Access, an object that carries if a user can access specific function of a specific Workflow. The Security Package supports this object.

3. Profile, a container object that carries everything about the user (e.g., Function Access objects, Virtual File object, Alert Box, Email address)

4. Virtual File, a tree like structure using the database to simulate a file system. Each Virtual File object contains Root, Node (directory) or Leaf (link to persistence object)

Deal BLL Package supports the creation, modification, and deletion of all financial instruments implemented in the system. Deal provides services to others in the forms of “Application Program Interfaces” (API) and “Templates.” Deal API specifies how to interact with Deal object in terms of setting and retrieving attributes. “Template” provides an abstraction of every specific instrument with their default attribute values and a single interface so that the calling routine does not have to aware of the internal construct of Deal object. Deal object contains enough information (attributes) to facilitate Legal Document formation and Market Analytic Calculation (e.g., cash flow and price-to-yield conversion).

Document BLL Package provides API to create, update, and delete document objects. It also supports other primitive functions like document merge, virus scan, and version control via the supports of Content Management System BLL (CMS).

Due Diligence BLL Package provides DD templates, which are a set of Microsoft Excel files containing fields for data that a company would have to provide during the course of conventional due diligence. This data covers detailed break-ups of account heads in the balance sheets, income statements and cash flow statements of companies. Users can download any of these templates, enter the required information and store them in their repositories. Templates cover both manufacturing and financial companies and are “linked,” i.e., once a set of related templates is downloaded, inputs in one template update the information in others.

Interest BLL Package provides Matching Engine, matches a Posting with a user's Interest Profile.

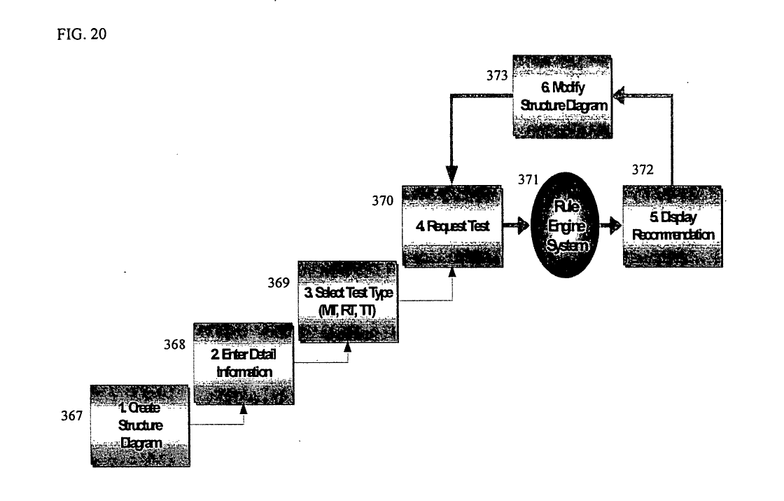

Referring now to FIG. 20, in the Rule Engines Package, the Rule Engine System 371 conducts a series of tests for a financial transaction model to evaluate the viability of the model. Rule Engine System 371 works with the Design package to realize iterative design paradigm. As described above, once a structure diagram is created 367 and attribute details are defined 368, a test of a given type may be selected 369 and requested 370 to be applied. The selected test is applied 371 and a response is generated 372 to inform the user of any issues raised any recommendations for modifications. The user may choose to modify the structure diagram 373. Test categories may include the areas of: Market Test, Regulatory Test, and Tax Test.

Regulatory Test checks the issues raised by a given financial structure diagram model, attributes, and input parameters when tested against sovereign regulations relating to an entity moving cash or assets between itself and other entities in the structure diagram. Foreign exchange laws, securities laws, corporate laws and banking laws of countries are collected, stored on a database and used to implement the Rule Engine System.

Market Test evaluates the financial market risk of a given financial structure diagram model, attributes, and input parameters when tested against a database of live market data (retrieved from market data feed) and pricing models.

Tax Test checks for any tax issues of a given financial structure diagram model, attributes, and input parameters when tested against sovereign regulations relating to taxation of an entity that is moving or issuing securities, cash, or assets between itself and other entities.

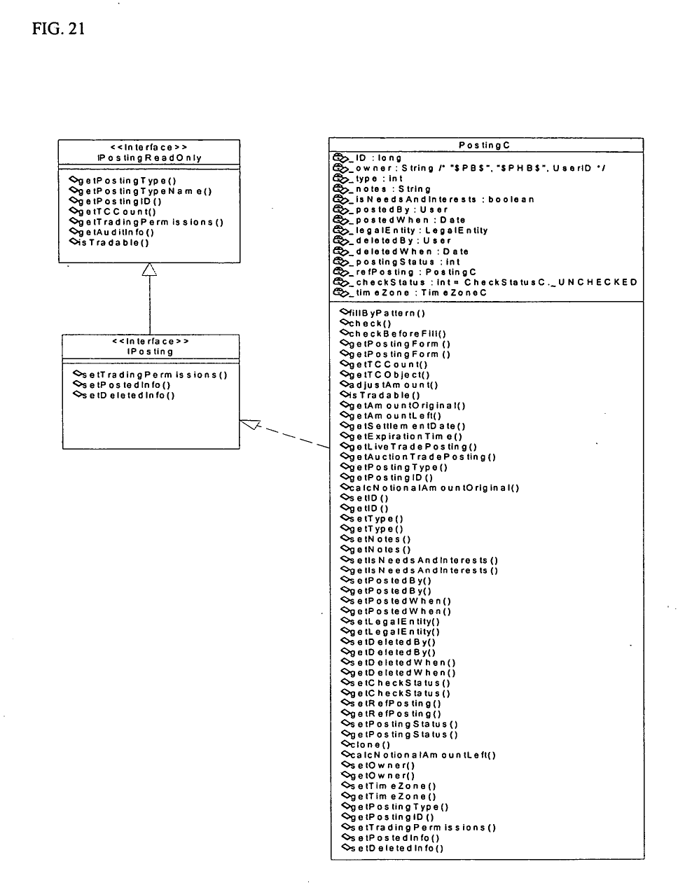

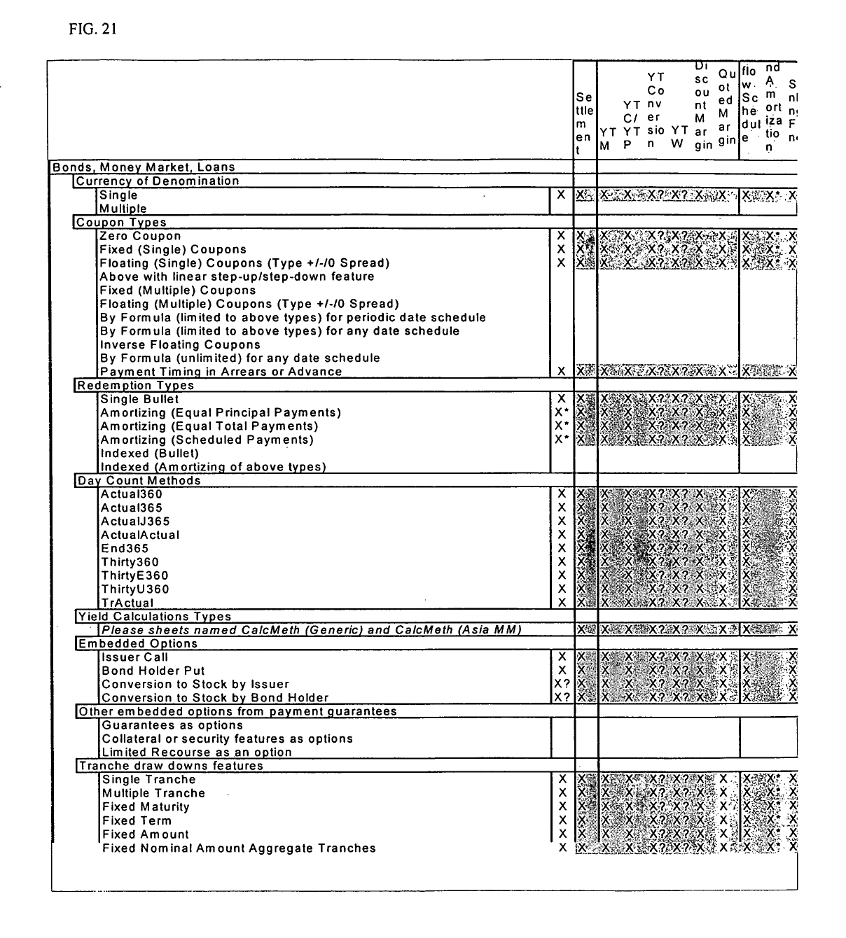

The Market Analytics package contains various calculation engines that takes an instrument and performs required calculation (e.g., price-to-yield). The table set forth in FIG. 21 sets forth the details of available functions.

Postings Package is a container, which contains multiple independent atomic objects, and can be placed on a Posting Board object (Posting Board BLL). Posting supports create, modify, delete, get/retrieve contents (structure), and remove contents.

Posting Board BLL Package is a “Singleton” object shared by all users of the system. It serves as the central repository where all the Postings are posted and supports Posting searches based on user specified parameters. The Posting Board is extended to support Primary Postings, Secondary Postings, Interest Postings, and Document Postings.

Security BLL Package provides low-level User, Group, Role, Function Access objects, and ties them to Web Logic Security Realm (Access Control List).

Trade BLL Package is a combination of Primary and Secondary Trade Business Logic. Refer to both BLL for more details.

Web Crawler Package searches the web using pre-defined public domain Search Engine (e.g., AltaVista) to search for any specific string on the web, and returns the corresponding URLs.

Obviously, numerous modifications and variations of the present invention are possible in light of the above teachings, and additional aspects and features of the invention will be apparent to those of skill in the art.

1. A method for executing business transactions, comprising:
designing a structure for a transaction diagrammatically and assigning corresponding attributes to the structure design;
creating and posting the transaction, wherein a user maintains control of the posting;
identifying a transaction of interest to a user; and
executing the transaction.

2. The method of claim 1, wherein the structure design is shared among users by providing access to the structure design to users of the system.

3. The method of claim 1, further comprising issuing new securities or buying or selling previously issued securities through an auction or trade process.

4. The method of claim 3, wherein new securities are issued through an on-line syndication.

5. The method of claim 3, further comprising:
drafting, preparing and finalizing documents to execute the transaction; and
conducting due diligence research on the transaction or on the issuer.

6. The method of claim 3, further comprising:
testing the structure design to evaluate the viability of the structure and identify potential issues of the transaction; and
communicating the test results and recommendations for modification of the structure to the user maintaining the posting.

7. The method of claim 6, wherein the testing comprises comparing the structure design and corresponding attributes against a database or data feed of market conditions, regulatory requirements or tax requirements.

8. The method of claim 6, further comprising modifying the structure design in accordance with the test recommendations.

9. The method of claim 3, further comprising analyzing a financial statement of a company or issuer to assess the company's or issuer's ability to meet the financial obligations of the transaction.

10. The method of claim 3, further comprising analyzing the effect of the transaction on a company's or issuer's financial statement.

11. The method of claim 10, wherein analyzing the effect of the transaction comprises generating projections of future financial statements to assess the credit risk of the company or issuer.

12. The method of claim 10, wherein analyzing the effect of the transaction comprises simulating the effect of financial instruments on the company's or issuer's financial statements.

13. The method of claim 10, wherein analyzing the effect of the transaction comprises superimposing the effect of an instrument's cash flows on the company's or issuer's financial statements.

14. A method for raising capital by executing financial transactions on the Internet, comprising:
designing a structure for a transaction diagrammatically, assigning corresponding attributes to the structure design and storing the structure design and corresponding attributes in a database;
creating and posting the transaction, wherein a user maintains the posting;
compiling and maintaining a database of user information and transaction information;
comparing the user information with posted transaction information to identify transactions of interest to a user;
communicating transaction information to the user interested in the posted transaction; and
executing the transaction.

15. The method of claim 14, further comprising issuing new securities or buying or selling previously issued securities through an auction or trade process.

16. The method of claim 15, wherein the new securities are issued through an on-line syndication.

17. The method of claim 14, further comprising:
compiling and maintaining a database of transaction documents;
accessing a transaction document from the database or creating a transaction document;
drafting, preparing and finalizing documents to execute the transaction; and
conducting due diligence research on the transaction or on the issuer.

18. The method of claim 17, further comprising on-line collaborative drafting and negotiating of documents by users of the transaction.

19. The method of claim 17, further comprising:
selecting professional services through an on-line auction by providing invitations to bid to work on the transaction, the invitation communicated by a user to other users.

20. The method of claim 17, further comprising:
building an offering memorandum on-line by collating document files; and
on-line tracking of confirmations of approval of the offering memorandum from each user participating in the transaction.

21. The method of claim 17, further comprising:
on-line building of a business plan comprising document files; and
on-line tracking of status of files.

22. The method of claim 17, further comprising:
interactively assisting a user to generate the user's final projections for a period of time into the future in the form of an income statement, balance sheet or cash flow statement.

23. The method of claim 14, further comprising:
compiling and maintaining a database or data feed of market conditions, regulatory or tax requirements;
testing the structure design to evaluate the viability of the structure and identify potential issues of the transaction by comparing the structure design and corresponding attributes against a database or data feed of market conditions, regulatory requirements or tax requirements;
communicating the test results and recommendations for modification of the structure to the user maintaining the posting; and
modifying the structure in accordance with the recommendations.

24. The method of claim 23, further comprising:
analyzing a financial statement of a company or issuer to assess the company's or issuer's ability to meet financial obligations of the transaction; and
analyzing the effect of the transaction on an issuer's financial statement.

25. The method of claim 14, further comprising:
generating a bill for a completed transaction;
sending the bill to a user's customer; and
providing a means for negotiating payment of bills between the user and the user's customer.

26. An Internet-based system for raising capital by executing financial transactions, comprising:
workstations for receiving transaction information from users, and for displaying transaction information to users;
a database component operative to maintain a database of user information and transaction information;
a load-balancing mechanism to distribute load across the system;
a system server;
a security means, including a firewall and network segmentation; and
a communication means that transmits communications between the users of the system and the system server, including transaction information to the user interested in the transaction.

27. An Internet-based system for raising capital by executing financial transactions, comprising:
workstations for receiving transaction information from users, and for displaying transaction information to users;
a storage device;
a system server;
a processor programmed to:
maintain in the storage device a database of user information and transaction information,
compare the database of user information with the posted transaction information to identify transactions of interest to a user,
communicating transaction information to the user interested in the posted transaction; and
a communication means that transmits communications between the users of the system and the system server, including transaction information to the user interested in the posted transaction.

28. A computer readable medium having computer executable instructions for performing a method for raising capital by executing financial transactions comprising:
designing a structure for a transaction diagrammatically and assigning corresponding attributes to the structure design;
creating and posting the transaction, the posting maintained by a user;
identifying transactions of interest to a user; and
executing the transaction, including issuing new securities or buying or selling previously issued securities through auction or trade.

29. The computer readable medium of claim 28, wherein the new securities are issued through an on-line syndication.

30. A method for executing financial transactions on a Web-based system, comprising:
providing a security means for controlling access to the system, the security means also comprising means for restricting access of the system to qualified users;
designing a structure for a transaction diagrammatically, assigning corresponding attributes to the structure design and storing the structure design and corresponding attributes in a database;
testing the structure design against market conditions, regulatory or tax requirements;
creating and posting the transaction, wherein a user maintains the posting;
compiling and maintaining a database of user information and transaction information;
identifying transactions of interest to a user;
communicating transaction information to the user interested in the posted transaction; and
executing the transaction, including issuing new securities or buying or selling previously issued securities through auction or trade.

31. The method of claim 30, wherein the new securities are issued through an on-line syndication.

32. The method of claim 30, further comprising:
providing an invitation to participate in a transaction, the invitation communicated by an manager to another user; and
providing an acceptance of the invitation to participate in the transaction, the acceptance communicated by the other user to the manager.

33. The method of claim 30, further comprising:
a request for permission to participate in a transaction, the request communicated by another user to the user maintaining the posting; and
a grant for permission to participate in the transaction, the grant communicated by the user maintaining the posting to the other user.

34. The method of claim 30, further comprising:
providing an offer for sale of an allocation of securities, the offer communicated by the manager or arranger to a user participating in the transaction; and
providing an acceptance of the offer, the acceptance communicated by the user participating in the transaction to the manager.

35. The method of claim 30, further comprising:
a bid to buy an instrument for sale by auction, the bid communicated by a user to the user maintaining the posting;
a means for determining the highest bid;
a communication providing the highest bid to buy to the user maintaining the posting;
an acceptance of a bid, the acceptance communicated by the: user maintaining the posting to the user communicating the bid to buy; and
an acceptance of the acceptance of the bid communicated by the user communicating the bid to buy to the user maintaining the posting.

36. A system for executing financial transactions on the Internet, comprising:
a system server;
means for storing data concerning users and transactions;
means for accessing data concerning transactions, capturing and processing data concerning the transaction attributes that are of interest to a user;
a communication means that transmits communications between the users of the system and the system server, including transaction information to the user interested in the transaction; and
means for executing the transaction, including issuing new securities or buying or selling previously issued securities through auction or trade.

37. A Web-based system for executing securities transactions comprising:
means for designing a structure for a transaction diagrammatically and assigning corresponding attributes to the structure design;
means for analyzing and testing the structure design against market conditions, tax or regulatory requirements;
means for posting the transaction;
means for identifying transactions of interest to a user; and
means for executing the transaction, including issuing new securities or buying or selling previously issued securities through auction or trade.

38. The Web-based system of claim 37, further comprising:
means for analyzing an issuer's financial statements to assess the issuer's ability to meet financial obligations of the transaction;
means for preparing and finalizing documents to execute the transaction; and
means for conducting due diligence research on the transaction or on the issuer.
